(19) United States
(12) Patent Application Publication
(10) Pub. No.: US 2010/0262461 A1
(43) Pub. Date: Oct. 14, 2010

(54) System and Method for Web-Based Consumer-to-Business Referral

(75) Inventor: James J. Bohannon, Pleasanton, CA (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: MYPOINTS.COM INC., San Francisco, CA (US)

(21) Appl. No.: 12/423,643

(22) Filed: Apr. 14, 2009

(51) Int. Cl. G06Q 30/00; G06F 15/16; G06Q 10/00; G06Q 20/00

(52) U.S. Cl. 705/10; 705/26; 709/206; 705/14.16

(57) ABSTRACT

A method for automatically crediting a registered user for referring a candidate third-party entity to an online system, where the candidate entity is at least one of a commercial, government, or non-profit entity where the online system facilitates transactions between a plurality of users and a plurality of participating third-party entities, and where the online commercial system maintains a personal account for each registered user, includes receiving a transaction request from the candidate third-party entity, receiving an identifier associated with the transaction request such that the identifier corresponds to the registered user, identifying the registered user using the identifier, retrieving a crediting rule associated with the transaction request, and automatically crediting the registered consumer in accordance with the crediting rule.

### TECHNICAL FIELD

The following disclosure relates to an information management system and, more particularly, to a system and method for automatically awarding members for recruiting business entities.

### BACKGROUND

Merchants, banking institutions, publishers of periodicals, survey collectors, and other providers of products and services frequently award customers for participating in promotional campaigns or surveys, accepting subscription or purchase offers, or simply making business-related inquires. Such awards may range from relatively inexpensive tokens of customer appreciation, such as small product samples, to substantial discounts on products or services, including direct monetary credit. Moreover, e-commerce has brought about an even greater number of promotions and advertisement campaigns which involve awarding customers for purchases made or for participation in a predefined activity. In general, e-commerce relates to various forms of commercial activity carried out over the Internet, or World Wide Web.

As is known, users of the World Wide Web distributed computing environment may freely send and retrieve data across long distances and between remote computing devices. The Web, implemented on the Internet, presents users with documents called “web pages” that may contain information as well as “hyperlinks” which allow the users to select and connect to related web sites. The web pages may be stored on remote computing devices, or servers, as hypertext-encoded files. The servers use Hyper Text Transfer Protocol (HTTP), or other protocols to transfer the encoded files to client users. Many users may remotely access the web sites stored on network-connected computing devices from a personal computer (PC) through a browser application running on the PC.

The browser application may act as an interface between user PCs and remote computing devices and may allow the user to view or access data that may reside on any remote computing device connected to the PC through the World Wide Web and browser interface. Typically, the local user PC and the remote computing device may represent a client and a server, respectively. Further, the local user PC or client may access Web data without knowing the source of the data or its physical location and publication of Web data may be accomplished by simply assigning to data a Uniform Resource Locator (URL) that refers to the local file. To a local client, the Web may appear as a single, coherent data delivery and publishing system in which individual differences between other clients or servers may be hidden.

Needless to say, the proliferation of inexpensive computers and affordable access to the Internet have resulted in the expansion of most markets and, in most cases, has significantly increased competitiveness of retailers. As a result, many of the online providers of products and services seek additional help in identifying potential customers or campaign participants (because these providers typically operate own web sites, they shall be referred to hereinafter as “web site proprietors”). For example, e-tailers may rely on advertisement banners displayed on a web site offering specialized news to target those who, by virtue of visiting the particular news site, are more likely to purchase a particular product. As another example, some web site proprietors purchase demographic information from an information gathering service or, alternatively, rely on the information gathering service to conduct highly focused, precisely targeted advertisement campaigns or to otherwise direct users to the proprietors' sites.

A system may provide web site proprietors with web site user demographics information and is generally described in U.S. Pat. No. 7,240,022, “DEMOGRAPHIC INFORMATION GATHERING AND INCENTIVE AWARD SYSTEM AND METHOD” to Bistriceanu et al., the entire disclosure of which is hereby incorporated by reference. Generally, the system may include users, web site proprietors, and an enterprise system hosting a central web site. The users may register with the central web site and may earn “points” for performing specific on- or off-line tasks in exchange for disclosing their demographic information during registration. The users may then redeem their earned points at participating proprietors for merchandise or services. Generally, the central web site manages the system by performing a number of tasks including: maintaining all user demographic information, tracking user point totals, and awarding points according to specific, proprietor-defined rules.

Web site proprietors, and clients of an information gathering system in particular, may display various offers to web site visitors. Typically, offers are displayed as advertisement banners, hyperlinks, or interactive animations rendered in HTML, JAVA, JAVASCRIPT, and other software tools widely available to web content developers. Because many web site proprietors offer a large variety of products, which may be in the form of goods or services, the proprietors may want to focus the advertisements in order to achieve a higher rate of “conversion,” or of web site visitors actually purchasing the offered products, clicking on the advertisement banners, following text-only hyperlinks, and similarly responding to the offers rendered on the page. In other words, web site proprietors generally attempt to use the information available from the visitors to the sites operated by the proprietors in order to “target” visitors for a particular type of product.

Moreover, targeted information may not be limited to advertisement. For instance, a web site proprietor operating a weather service may display information specific to the geographic area from which a particular visitor is accessing the web site. As another example, some web sites provide interactive services for which web site proprietors retain user-specific information in databases, such as banks offering online services to bank customers. In this case, a web server servicing online requests may similarly render user-specific information, such as the name of the user, his or her account balance, and a list of nearest bank locations to a web site visitor after ascertaining and confirming his or her identity through a login process.

However, the information gathering and promotional techniques discussed above have had only a limited impact on local or small businesses that have relatively little exposure on the internet. For example, a restaurant may wish to attract local customers by offering free dessert with a dinner entree. For obvious reasons, it is inexpedient to target large numbers of subscribers of such information gathering service in a mass email campaign, even after selecting those subscribers that are likely to find the offer appealing based on the reported preferences, income, and other demographic factors. Proper selection of a target audience for the offer may also be complicated in those common situations where a subscriber chooses to specify his or her locality very generally (e.g., “New York”), or not provide this information at all.

In another aspect, small businesses may lack motivation to promote offers on the internet or via other electronic means. Whereas a bookseller, for example, may ship products nationally, a restaurant, a dry cleaning service, or a car mechanic may not expect internet exposure to significantly impact the existing customer base.

As a result, companies that offer advertisement services generally find it difficult to attract local, and particularly small, businesses and other organizations. To reach to small businesses, these companies typically rely on such traditional techniques as direct sales (through dedicated sale teams, for example), partnerships with other websites, and advertising online, in newspapers, or on television. These companies also rely, to at least some extent, on word-of-mouth and publicity in general.

Yet despite these efforts, online advertisers typically succeed in recruiting only a small percentage of local businesses. Moreover, the cost of recruiting small businesses is very high, particularly when companies hire large numbers of salespeople to reach out to local businesses. An online advertiser www.local.com, to take one example, spent 84.2% and 94.2% of total revenue on sales and marketing expenses in 2008 and 2007, respectively, according to the company's 10-K filings. Clearly, the cost of sales for local advertisers is very high. Meanwhile, the 2008 10-K report by Marchex, Inc., another online advertising company, asserts that there are more than 15 million small business in the United States but fewer than 1 million of these businesses currently advertise online.

### SUMMARY

An online enterprise system implements an automated, cost-effective method of attracting a large number of local businesses and non-commercial organizations. In some embodiments, a customer refers a business entity to the online enterprise system, and the online enterprise entity automatically credits the referring customer for a business transaction between the referred business entity and the online enterprise system. In some embodiments, the online enterprise system may be an information gathering system that facilitates transactions between users, including but not limited to registered members, and participating business entities such as merchants, banking institutions, publishers, survey collectors, etc. In an embodiment, the online enterprise system may gather demographic data related to users to assist these and other users in locating products and services based on the gathered and extrapolated information, as well as the participating merchants in targeting proper demographic groups in advertisement campaigns and other user-related activities. The enterprise system may also award registered members for submitting demographic information, making purchases from participating merchants, and interacting with participating business entities in a predetermined manner. In some embodiment, the enterprise system may maintain, for each registered member, an account of award points redeemable for products and services.

In some embodiments, the enterprise may assign a unique member identifier to each registered member which can be subsequently provided to candidate business entities such as, for example, a local restaurant. The candidate business entity may then contact the enterprise system to register as a participating merchant or to conduct some other business transaction. In some embodiments, the candidate business entity may conduct the business transaction via a web page configured to accept, in part, the member identifier corresponding to the referring member or a referral code unique to the referring member. Additionally or alternatively, the web page may accept the full or partial name of the registered member and search for the member in a member database. In this or other embodiments, the online enterprise system may receive the initial business transaction request from the candidate business entity in an email message including the identifier of the referring member, or via another form of electronic communication.

Upon receiving the business transaction request including or otherwise associated with the identifier of the referring member, the enterprise system may automatically allocate a predefined amount of award points to the member's account. In some configurations, the enterprise system awards points only upon a successful registration of the candidate business entity with the enterprise system or upon a completion of a monetary transaction of a predetermined amount between the enterprise system and the candidate business entity. In yet another embodiment, the enterprise system rewards the referring member in proportion to the amount of money the candidate business entity spends with the enterprise system on consumer promotions and similar activities, or according to some other economic metric.

In some embodiments, the enterprise system may also ensure that the candidate business entity identifies the referring member in the initial business transaction request by offering a discount or another incentive to candidate business entities that claim a referral by a participating user.

Upon registering with the online enterprise system, a business entity may wish to limit advertisement campaigns or other available services to a local area only. In some embodiments, the business entity may specify the locality using one or several zip codes, for example, and the enterprise system may automatically identify registered members that are associated with the specified locality. In an embodiment, the enterprise system may provide the registered business entities with an actual or projected number of members that can be targeted in the specified locality. The business entity may accordingly select the desired form and scope of advertisement.

In some embodiments, the online enterprise system may personalize a “home” page for each registered member according to his or her preferences and the available demographic information, which may include precise or approximate (e.g., zip code, city neighborhood, etc.) geographic information. Depending on the arrangement with one or several business entities geographically proximate to the member, the online enterprise system may display advertisement for the local business entities in the form of banners, interactive links, etc. Additionally or alternatively, the online enterprise system may disseminate promotional information for one or several local business entities to corresponding members via email, text messaging, or other forms of electronic communication.

In some embodiments, the enterprise system may identify one or several localities associated with a registered member by tracking IP addresses associated with the member's transaction. For example, a certain registered member may systematically check her account from a home computer with a static IP address, from a work computer that dynamically acquires an IP address within a certain IP address class C, and from a cell phone that dynamically acquires an IP address for each session out of a large pool of addresses. Accordingly, the online enterprise system may associate the member with a first locality based on the static IP address and a second locality based on the range from which the work computer obtains the IP address. The online enterprise system may further discard or ignore data corresponding to transactions from other IP address groups as erratic or potentially erroneous. In at least some embodiments, the online enterprise system may calculate a statistical correlation between one or several IP address class C ranges and ZIP code information available from some of the registered members. Additionally, the online enterprise system may extrapolate ZIP code information for some registered members who chose not to submit ZIP code or other geographic information from the IP addresses associated with transactions originated by these registered members.

In some embodiments, the enterprise system may define a plurality of geographic clusters and associate each cluster with one or several ZIP codes, one or more ranges of IP addresses, or both. The enterprise system may then target members within certain clusters in local advertisement campaigns to improve the overall efficiency of consumer promotions and allow local business to effectively advertise within the relevant geographic areas.

### BRIEF DESCRIPTION OF THE DRAWINGS

FIG. 1 is a diagram of one example of a network in which the system and method described herein may be implemented.

FIG. 2 is a diagram of one example of a general computing device that may operate in accordance with the claims.

FIG. 3 is a diagram of one example of an enterprise system including two groups of servers, a web server, and a firewall as connected to the network of FIG. 1.

FIG. 4 is a flowchart describing a method of one example of using the system of FIG. 3 to award points in exchange for demographics information.

FIG. 5 is another diagram of one example of an enterprise system including a load balancer, a plurality of member server groups, and a single administrative server group.

FIG. 6 is another flowchart describing a method of one example of using the systems of FIGS. 5, 7, and 8 to award points in exchange for demographics information.

FIG. 7 is another diagram of one example of an enterprise system including twelve member server groups and a single administrative server group.

FIG. 8 is another diagram of one example of an enterprise system including a plurality of member server groups, a single administrative server groups, and several components and systems that may enhance system function.

FIG. 9 is a diagram illustrating the interaction between the enterprise system illustrated in FIGS. 3-8 and registered members accessing the enterprise system via computers located in various geographic areas.

FIG. 10 is a schematic representation of a mechanism according to which the enterprise system illustrated in FIGS. 3-8 determines geographic clustering of the registered members.

FIG. 11 is a flowchart illustrating one example of a routine that generates geographic clustering information in accordance with the mechanism illustrated in FIG. 10.

FIG. 12 is a flowchart illustrating one example of a routine that processes a request to conduct a business transaction such as a promotion campaign directed at customers within a certain specified geographic area.

FIG. 13 is a diagram illustrating one example of a method for automatically awarding a registered member for referring a business entity to the enterprise system illustrated in FIGS. 3-8.

FIG. 14 schematically illustrates several elements of the enterprise system illustrated in FIGS. 3-8 that support the techniques illustrated in FIGS. 9-13.

FIG. 15 is a flowchart illustrating one example of a procedure the enterprise system illustrated in FIGS. 3-8 may implement to award users for business entity referrals.

FIG. 16 is a schematic illustration of one example of a web page which the enterprise system illustrated in FIGS. 3-8 may present to a registered member to provide information about consumer promotions available in the member's geographic area.

### DETAILED DESCRIPTION

An enterprise system, such as an information gathering system discussed in detail below, implements an efficient technique for reaching out to local organizations in general and to businesses in particular. The enterprise system mobilizes large numbers of consumers who may already be enrolled in some program associated with the enterprise system (e.g., incentive marketing subscription) by crediting the consumers for referring local businesses to the enterprise system. More specifically, the enterprise system may credit consumers by providing a share of the benefit, a fixed monetary award, a certain number of award points, or other benefit. These techniques provide an immediate geographic coverage for any business that already has a large consumer base (e.g., a bank, a supermarket, etc.). If desired, the enterprise system may reward consumers only for successful referrals to reduce the cost of sales. As discussed below, the enterprise system may use the consumer base only sporadically, thereby eliminating traditional employment concerns. In some embodiments, the enterprise system may dynamically alter referral awards promised to consumers according to perceived expansion needs or other principles. Importantly, the enterprise system implements referral award techniques in a fully automated manner, and accordingly requires only a minimal administrative overhead.

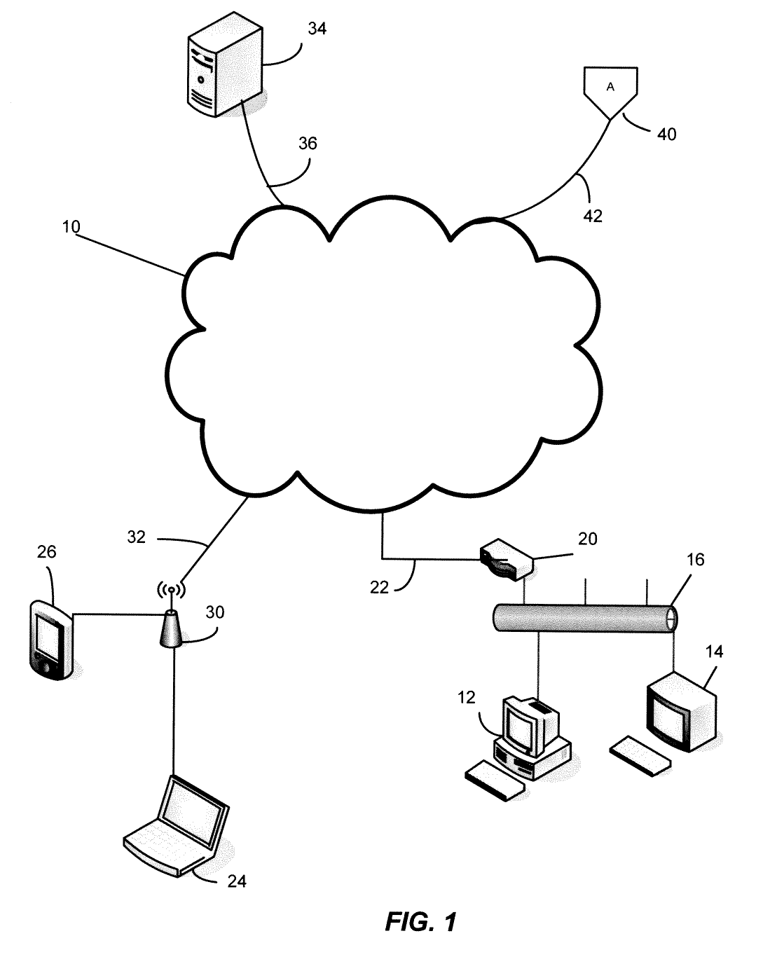

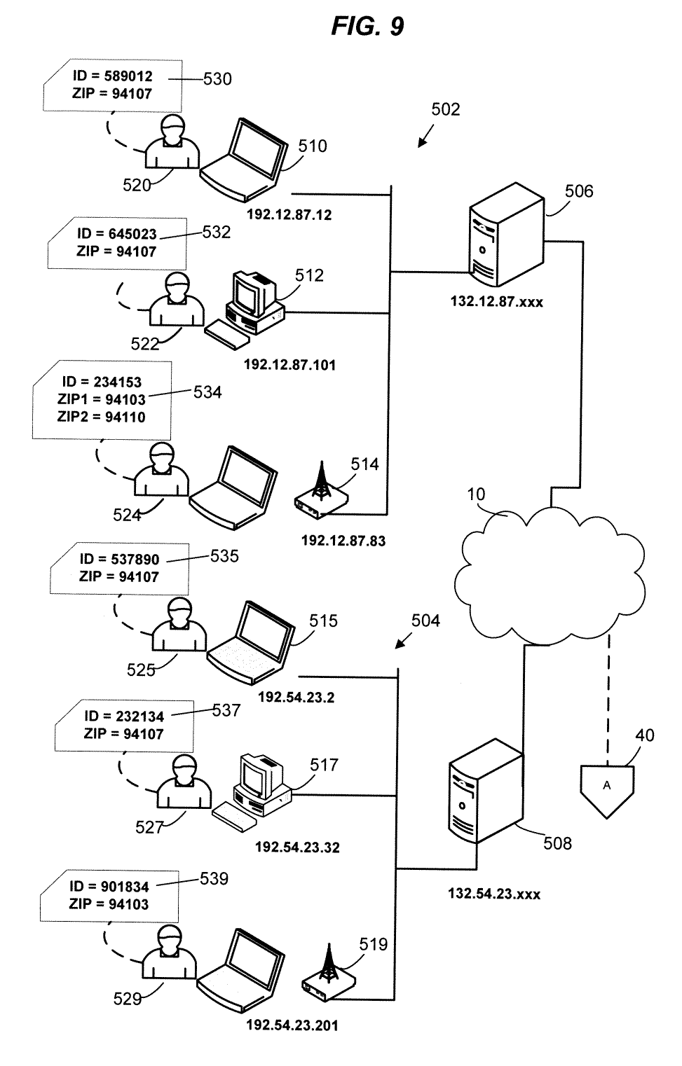

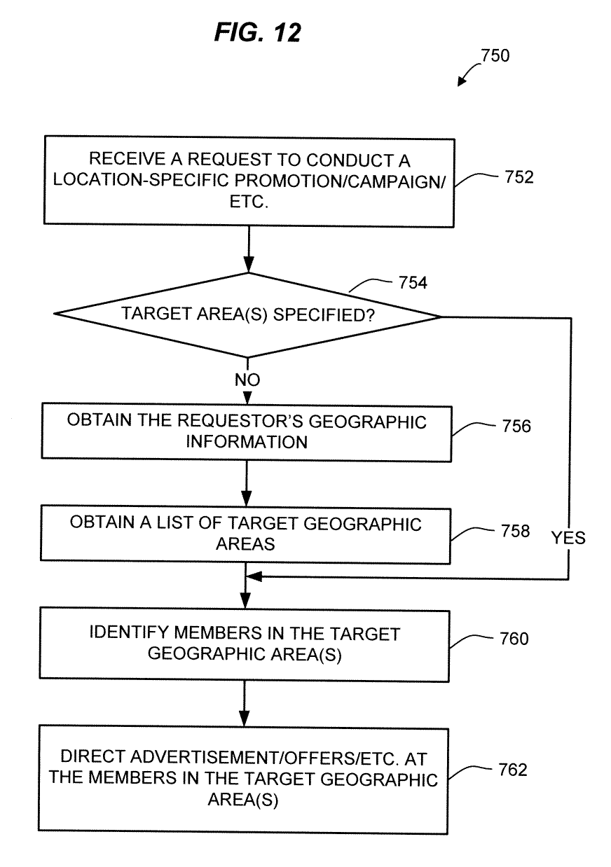

An example information gathering system which may implement such referral award techniques is discussed next with reference to FIGS. 1-8. Geographic clustering techniques are then discussed with reference to FIGS. 9-11, followed by a discussion of referral techniques illustrated in FIGS. 12-16.

### An Information Gathering System

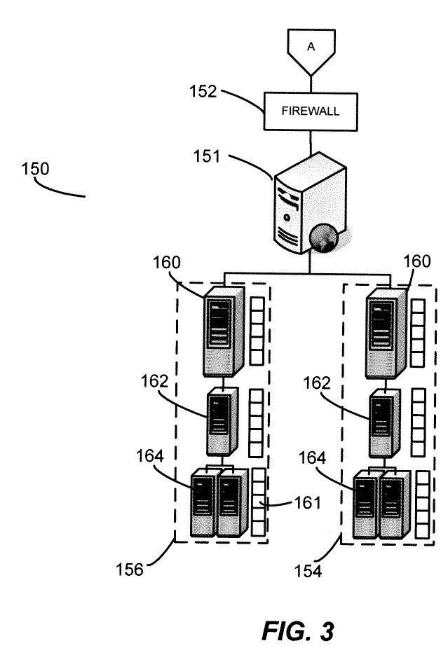

FIG. 1 illustrates an example of a network typical of the World Wide Web. A network 10 may be a virtual private network (VPN), or any other network that allows one or more computers, communication devices, databases, etc., to be communicatively connected to each other. The network 10 may be connected to a PC 12 and a computer terminal 14 via an Ethernet 16 and a router 20, and a land line 22. The network 10 may also be wirelessly connected to a laptop computer 24 and a personal data assistant 26 via a wireless communication station 30 and a wireless link 32. Similarly, a server 34 may be connected to the network 10 using a communication link 36. Also, an enterprise system 40 for awarding points to registered users in exchange for demographic information, as generally illustrated in FIGS. 3, 5, 7, and 8 may be connected to the network 10 using another communication link 42. Where the network 10 includes the Internet, data communication may take place over the network 10 via an Internet communication protocol. In operation, the client PC 12 may view or request data from any other computing device connected to the network 10. Further, the PC 12 may send data to any other computing device connected to the network 10.

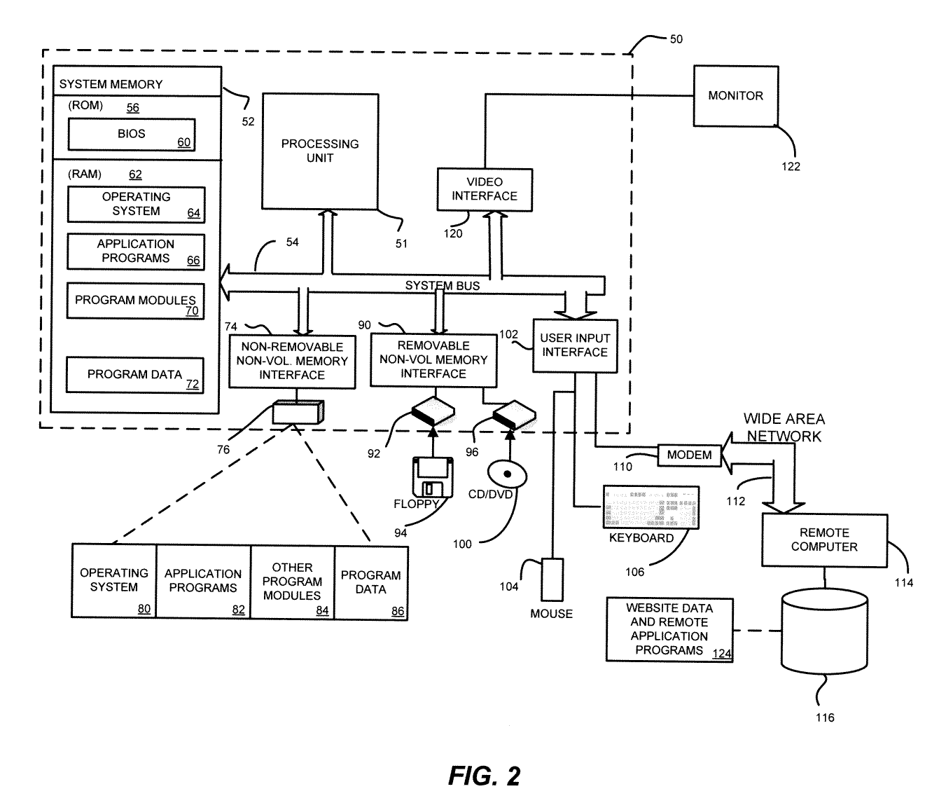

FIG. 2 illustrates a typical computing device 50 that may be connected to the network 10 of FIG. 1 and participate in a distributed computing environment such as the World Wide Web. FIG. 2 may also be an example of an appropriate computing system on which the claimed apparatus and claims may be implemented, however, FIG. 2 is only one example of a suitable computing system and is not intended to limit the scope or function of any claim. The claims are operational with many other general or special purpose computing devices such as PCs 12, server computers 34, portable computing devices such as a laptop 24, consumer electronics 26, mainframe computers, or distributed computing environments that include any of the above or similar systems or devices.

With reference to FIG. 2, a system for implementing the blocks of the claimed apparatus may include several general computing devices in the form of a computer 50. The computer 50 may include a processing unit, 51, a system memory, 52, and a system bus 54 that couples various system components including the system memory 52 to the processing unit 51. The system bus 54 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus. The computer 50 may include an assortment of computer-readable media. Computer-readable media may be any media that may be accessed by the computer 50. By way of example, and not limitation, the media may include both volatile and nonvolatile media, removable and non-removable media. Media may also include computer storage media and communication media. Computer storage media may include volatile and nonvolatile, removable and non-removable media that stores information such as computer-readable instructions, program modules, data structures, or other data. Computer-storage media may include RAM, ROM, EEPROM, or other memory technology, optical storage disks, magnetic storage devices, and any other medium which may be used to store computer-accessible information. Communication media may be computer-readable instructions, data structures, program modules, or other data in a modulated data signal or other transport mechanism. Communication media may include wired media such as a wired network or direct-wired connection, and wireless media such as RF, infrared, and other wireless media.

The system memory 52 may include storage media in the form of volatile and/or non-volatile memory such as ROM 56 and RAM 62. A basic input/output system 60 (BIOS), containing algorithms to transfer information between components within the computer 50, may be stored in ROM 56. Data or program modules that are immediately accessible or are presently in use by the processing unit 51 may be stored in RAM 62. Data normally stored in RAM while the computer 50 is in operation may include an operating system 64, application programs 66, program modules 70, and program data 72.

The computer 50 may also include other storage media such as a hard disk drive 76 that may read from or write to non-removable, non-volatile magnetic media, a magnetic disk drive 251 that reads from or writes to a removable, non-volatile magnetic disk 94, and an optical disk drive 96 that reads from or writes to a removable, nonvolatile optical disk 100. Other storage media that may be used includes magnetic tape cassettes, flash memory cards, digital versatile disks, digital video tape, solid state RAM, and solid state ROM. The hard disk drive 76 may be connected to the system bus 54 through a non-removable memory interface such as interface 74. A magnetic disk drive 92 and optical disk drive 96 may be connected to the system bus 54 by a removable memory interface, such as interface 90.

The disk drives 92, 96 transfer computer-readable instructions, data structures, program modules, and other data for the computer 50 to different storage media 94, 100 for storage. A hard disk drive 76 may store an operating system 64, application programs 66, other program modules 70, and program data 72. These components may be the same or different from operating system 64, application programs 66, other program modules 70 and program data 72. The components associated with the hard disk drive 76 may be different copies than those associated with RAM 62.

The user may interact with the computer 50 through input devices such as a keyboard 106 or a pointing device 104 (i.e., a mouse). A user input interface 102 may be coupled to the system bus 54 to allow the input devices to communicate with the processing unit 51. A display device such as a monitor 122 may also be connected to the system bus 54 via a video interface 120.

The computer 50 may operate in a networked environment using logical connections to one or more remote computers 114. The remote computer 114 may be a PC 12, a server 34, a router 20, or other common network node as illustrated in FIG. 1. The remote computer 114 typically includes many or all of the previously-described elements regarding the computer 50, even though only a memory storage device 116 is illustrated in FIG. 2. Logical connections between the computer 50 and one or more remote computers 114 may include a wide area network (WAN) 112. A typical WAN is the Internet. When used in a WAN, the computer 50 may include a modem 110 or other means for establishing communications over the WAN. The modem 110 may be connected to the system bus 54 via the user input interface 102, or other mechanism. In a networked environment, program modules depicted relative to the computer 50, may be stored in the remote memory storage device 116. By way of example, and not limitation, FIG. 2 illustrates website data and remote application programs 124 as residing on the memory device 116. As may be appreciated, other means of establishing a communications link between the computer 50 and the remote computer 114 may be used.

As previously described, the system may award users with redeemable points for many reasons, such as, in exchange for collecting and releasing user demographic information to proprietors or clients and for users taking any action associated with a “campaign,” or set of rules negotiated by the proprietor. As used herein, a user or member may be any person, apparatus, method, or the like that employs a computing device 50 to access the system to earn redeemable points by completing proprietor-defined tasks in exchange for submitting and releasing demographic information to the system.

Further, as used herein, “demographic information” may be broadly construed and may include any kind of member descriptive data, any activity associated with a member, or any transaction associated with a member. Demographic information may be gathered by the system upon user registration in the form of a questionnaire designed to solicit various demographics data of interest to the proprietors. The questionnaire may be in the form of a website page or any other format able to collect demographics information from the user. Users may register in a variety of ways including direct registration at the central web site hosted by the enterprise system, registration through web site proprietors, a web based “refer-a-friend” program, third-party direct mailing, or other partner relationships. A user may need only to register with the system once. However, the user may earn additional points by completing future, supplementary questionnaires. Typical examples of information gathered by the questionnaires may be the user's age, income, occupation, etc. Further, the system may award a user for specific actions such as viewing web-based content, purchasing goods or services through a system-sponsored website, a proprietor's website, a proprietor's brick-and-mortar facility, or any other action associated with the system. The demographics information, to include but not limited to information gathered by questionnaire or records of any user action taken at the suggestion of or related to the system and a proprietor campaign, may be aggregated into a unique user profile. Once the user creates a profile, all future user activity within the system may be uniquely associated with the user's profile. A user may participate in the system by using a network 10 and a PC 12.

Further, as used herein, a proprietor or client may be any entity, corporation, web site manager, business owner, or the like that coordinates with the system by submitting a set of proprietor-defined award rules or tasks that a user may complete to earn redeemable points. The proprietor may also purchase user demographic information from the system and provide product price reductions or other benefits to users in exchange for user demographic information, or may complete any combination of these functions. This set of proprietor-defined rules or tasks may be called a “campaign.” Each campaign may further include a template for e-mails to be sent by the system to targeted users. A proprietor may compensate the system for receiving the users' demographic information in a number of ways including: monthly sponsorship fees for the system displaying their offers on the central web site; per action fees when users follow specific actions provided to the system; per click fees for users clicking on hyperlinks provided in targeted e-mails advertising proprietor services or products and directing the user to a proprietor Web page; per e-mail delivery fees; advertisement placement within “newsletter” e-mails that the system may send to all system-registered users; and other fee combinations including indirect, agency relationships between proprietors and the system. Also, the system may compensate a proprietor for soliciting new memberships. The system may further automate billing clients based on a set billing rules within each campaign. The billing rules may be associated with award rules and user activity. For example, within a particular campaign, an award campaign rule may award a member two hundred points for making a single purchase with a proprietor. The campaign may also include a billing rule indicating that the proprietor may be billed at five percent of all purchases made by the member, even though only the first transaction awarded points. Also, a proprietor may customize its campaign to award a user points in a variety of methods. For example, a proprietor may choose the number of points to be awarded to users, may specify activities or questions that must be completed by the user before points are awarded, or may limit the frequency at which users can be awarded points for visiting the site. A proprietor may also dictate different user questionnaires during the registration process or may provide an additional questionnaire as a user task to be completed by the user to earn additional points.

Also, as used herein, the system may refer generally to the method or apparatus that coordinates user and proprietor functions by collecting user demographic information, awarding redeemable points to the users, tracking points for the users or proprietors, aggregating statistical information concerning user activity and the demographic information, maintaining the proper function of all user and proprietor activity, providing statistical and demographic information to the proprietors, sending targeted e-mail to the users, and executing any other management or coordination functions. The targeted e-mails may contain hyperlinks that direct users to proprietor offers that may award or redeem points to a specific user account. The system may be a collection of devices, typically general purpose computing devices 50, servers, 34, and data stores connected to and in communication with a user PC 12 through a network 10.

A system for collecting demographics information in exchange for awarding redeemable points may include a variety of structures and components as generally described in relation to FIGS. 3, 5, 7, and 8. Therefore, the system configurations described in relation to FIGS. 3, 5, 7, and 8 may include any combination of elements described in relation to each figure.

With reference to FIG. 3, the system 150 may include an architecture that is N-tier with a web server 151 in communication with a system firewall 152 through which a user may access a website hosted on the web server 151 by the system 150. The system firewall 152 may provide a secure, high-speed connection to a computer network such as the Internet as illustrated in FIG. 1. The web server 151 may face the users and communicate with a number of server groups or “silos” such as silo 154 and silo 156. A silo may be a conceptual collection of servers that work together through an application interface. Each silo may include, for example, an application server 160 that may execute a system application program 161.

With reference to FIG. 2 and FIG. 3, a system application program 161 running on the application server 160 may be an application program 66 or a remote application program 124 and may perform any coordination, transformation, or update process on the data entering or exiting a master data server 162. Further, a system application program 161 may execute on any general computing device 50 or any system 150 component. A system application program 161 running on the application server 160 may include, for example, any combination of an e-mail engine, a query engine, a validation engine, a crypto engine, an award engine, or a transaction engine.

Returning to FIG. 3, the application server 160 may communicate between the web server 151 and a master data server 162 to pass data from the web server 151 or to pass data generated by the system application programs 161 to the master data server 162 or any other system 150 element. The master data server 162 may include a portion of the total system 150 data, consisting of, for example, user demographic data, campaign data, and any other data used by the system 150. In turn, the master data server 162 may communicate with replication data servers 164. The replication data servers 164 may include a duplicate copy of the user profile data assigned to the silos 154, 156.

The system capacity is expanded simply by adding more silos 154, 156. The silos 154, 156 may also provide specialized functions within the system 300. For example, the silo 156 may be an administrative silo 156. The administrative silo 156 may be used by the system 150 to manage system information, campaign information, or any other information not related to the user profiles. The administrative silo 156 may also include a lookup table that may direct any data queries to the correct member silo 154. The administrative silo 156 may combine several different functions together, or it may be split apart into separate silos. For example, one administrative silo may contain campaign information while a separate administrative silo may contain a lookup table to direct any data queries to the correct member silo 154. Alternatively, there could be a third administrative silo which manages, for example, inventory information for redemptions. Thus, the administrative functions need not be confined to a single administrative silo. It should be noted that separating some functions into multiple administrative silos may increase the scalability of the system as a whole.

The member silo may hold the system 150 member information. The member information may include, for example, the user profile, demographics data, transactions, or point balances. As illustrated in FIG. 3, a system comprising one member silo 154 may hold approximately 100% of the total system 150 user information. Upon registration, a member's information may be stored in the member silo 154. The silo containing the member's registration data may be called the member's “home silo.” Each member's information may be kept in the member's “home silo.” However, when more member silos are added to the system 150, the member's information may be moved to one of the new silos, if desired. As an overview, members are assigned a large variety of attributes, which may be stored in each member's profile contained within a member silo 154 as member attributes. Member attributes may include a wide variety of information about the member, including, but not limited to, demographic information, member activity information, information derived from other member attributes, etc. For example, an external process may monitor past activity of a member and update the information in the corresponding member attribute. Member attributes may be described as a question and a response, where a member's choice of one or more answers to the question is stored as the response and indicates the presence or absence of a particular response in the member profile. In some instances, a member may not provide a response, in which case the question of the member attribute does not include a response. Initially, the same questions may be provided to all of the members, however, the answers to the questions may prompt subsequent questions that are not the same for all the members. For example, a member who provides a response of “male” in response to the question “gender” may be prompted with subsequent questions directed to a male demographic, whereas a member who provides a response of “female” to the question “gender” may be prompted with subsequent questions directed to a female demographic. In addition, the questions may include multiple answers. For example, a member may be prompted to provide information about sporting activities that interest the member with the question “sports,” and the member may choose a single answer such as “football” as a response, choose multiple answers such as “football,” “baseball” and “basketball” as a response or set of responses or choose no answer at all.

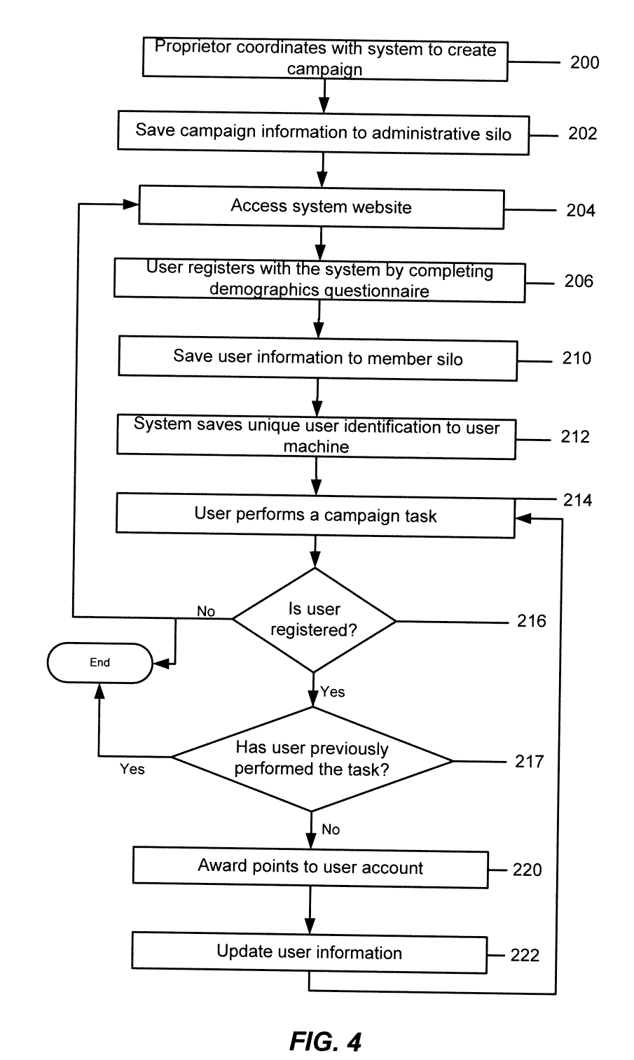

With reference to FIG. 1, FIG. 3, and FIG. 4, a method employing the enterprise system 300 may provide a user with a number of redeemable points for the user's submission of demographic information and participation in a variety of ecommerce related activities, including making purchases from proprietors. The user may then redeem their points for products and services from the participating proprietors such as retailers, theaters, restaurants, airlines, and hotels, among others. At block 200, a proprietor may coordinate with the system 150 to create a campaign. For example, the proprietor may request information from the system 150 to target a specific demographic variable such as age, gender, income, or job. At block 202, the campaign information may be distributed to the silos 154, 156 and distributed across all system master data servers 162. At block 204, a user may login to the system 150 using a general purpose personal computer (PC) 12 connected to a network 10 such as the Internet.

As previously described, at block 206, the user may register with the system 150 by accessing a web site hosted by the system 150 at the web server 151. During registration, the user may complete a demographics questionnaire in the form of a web site or other electronic document. The demographics questionnaire may include various questions concerning the user's background including, for example, the user's age, sex, zip code, job title, or marital status. The system, 150 may collect the demographics data in a variety of formats including free fom text, drop down menu selections, or Boolean values.

At block 210, the user's registration information and demographic data may be saved to a member silo 154. At block 212, the system may save a unique user identification to the users PC 105. The unique user identification may be used by the system to associate proprietor campaign tasks and user actions to award points. The unique user identification may be encrypted in the form of a “cookie” associated with the user's browser that may be used to associate the user with the registration information stored on the administrative silo 156. Further, the system may assign a 64-bit random number to each user upon registration. Because of the extremely low statistical probability of assigning identical 64-bit random numbers to more than one member upon registration, the system 150 need not verify that the random number has been previously assigned. The random user identification assignment may allow the system 150 to more easily select random user demographic information for analysis. Particularly, because the numbers are randomly assigned, any set of records associated with a sequential selection of the random user identifier may be very unlikely to overlap with any other set chosen by the random number. Because the probability of the system 150 assigning identical 64-bit random numbers is very small, and a few identical numbers will have very little effect on statistical analysis, it may be unnecessary to ensure that a random number has not been previously assigned.

At block 214, the user may perform any of the tasks or actions specified in the proprietor's campaign stored on the administrative silo 156 to earn redeemable points. For example, a campaign task may be visiting the proprietor's web site or responding to a system 150 generated e-mail.

Each proprietor web site may include a visual cue that the web site is a member of the points-awarding program. The visual cue may include a hyperlink pointing to the web server 151. The hyperlink may include a code called an “cell identification” that may optionally be encrypted and may associate the user's selection of the hyperlink with a campaign task saved on the administrative silo 156. Further, the cell identification may provide information associated with all campaign rules. A user may also receive and select hyperlinks associated with a proprietor's campaign in an e-mail message generated by an e-mail engine running as a system application program 161 on the replication server 164.

The e-mail engine could alternatively be run on the application server 160. However, to increase efficiency, the e-mail engine is run on one or more of the replication servers 164 on each member silo 154. In this way, the e-mail engine communicates locally with the database, avoiding network traffic and also avoiding additional load on the application server 160 which is servicing member requests in real-time. This is possible because the e-mail engine is able to work with a replicated copy of the member information. This provides for a great deal of scalability, as additional replication servers 164 could be added. For example, the replication servers 164 could be increased from two to four so that more than one e-mail engine is running for a given member silo 154.

At block 214, the administrative silo 156 and the application server 160 may validate the user's registration with the award program by comparing the user's cookie file with the registration information stored on the administrative silo 156. The validation process may be performed by a validation engine running as a system application program 161 on the application server 160. If the information received by the application server 315 is encrypted, a crypto engine running as a system application program 161 on the application server 160 may decrypt the information. If the user is not registered, at block 216, the process may terminate or, alternatively, the user may be directed to the system registration web site at block 204. If the user is validly registered, the system 150 may proceed to block 217.

At block 217, the validation engine may determine if the user has previously completed the campaign task associated with block 214. As described above, awarding points may be conditional and defined by the proprietor campaign rules. The campaign tasks and rules may be defined by the proprietor and stored on the administrative silo 156 or distributed across all system 150 silos 154, 156. The tasks and rules may be indexed on the administrative silo 156 by the cell identification. Using the cell identification, the validation engine may determine that a particular cell identification has been previously used, also indicating that the user has previously performed the task and that the user is ineligible for additional points. If the user has previously performed the task, the system 150 may terminate or direct the user to perform a different task. If the user has not yet performed the task, the system may proceed to block 220.

At block 220, if the user is validly registered and has not yet performed the present campaign task, a transaction engine running as a system application program 161 on the application server 160 may award a predetermined number of points to the user's account saved on the member's home silo 154 by associating the campaign task, cell identification, and point quantity with the unique user identification. It should be noted that this block is optional, as are many of the blocks in FIG. 4. The system could be configured to award points or perform actions in numerous alternative ways, such as, for example, once, daily, unlimited, other, etc. In other words, the system may be configured to keep track of whether a user has performed a required task before, and whether additional performances of the task could earn additional points. It is also noted that the system might do things other than award points, such as, for example, directly awarding something else of value, such as a gift card, updating a member's profile information, sending a message to the member, sending a message to a client about the member, changing the member's account status, or numerous other things. One of ordinary skill in the art will readily appreciate that there are various ways of paginating data and the system could be configured to do any of them.

At block 222, the transaction engine running as a system application program 161 on the application server 160 may update transaction information associated with the user at the member's home silo 154. Transaction information may later be used by the system 150 to develop demographic information and statistics associated with the user actions to provide to the proprietors. Therefore, upon visiting the proprietor site, the system 150 may automatically award points to the registered user without requiring the user to leave the proprietor web site. The system 150 may be distributed across multiple participating web sites and may operate without the knowledge of the user. Optionally, the proprietor's web sites may determine whether a web site visitor is one of the participating users.

The system 150 may also provide hyperlinks to redemption sites at which the users may convert earned points into products or services. The hyperlinks may be embedded in e-mails generated by the e-mail engine system application program 161. Further, the hyperlinks may point to redemption web sites hosted by the system 150 or on hosts at any other proprietor-designated site. The system 150 may automatically accept redemption orders, place purchase orders with vendors for the requested product or service, and may direct the proprietor or vendor to deliver the redeemed products to the user. The points may be automatically deducted from the user's account.

The system 150 may also develop demographic information and statistics to provide for the proprietors. The system 150 may associate the user demographic information with the user's actions associated with the proprietor or any other web site. For example, the percentage of the males visiting a particular web site or web pages may be calculated by looking at each participating visitor in the member silo 154, checking a field in the member silo 154 for each member's sex, and tabulating the results.

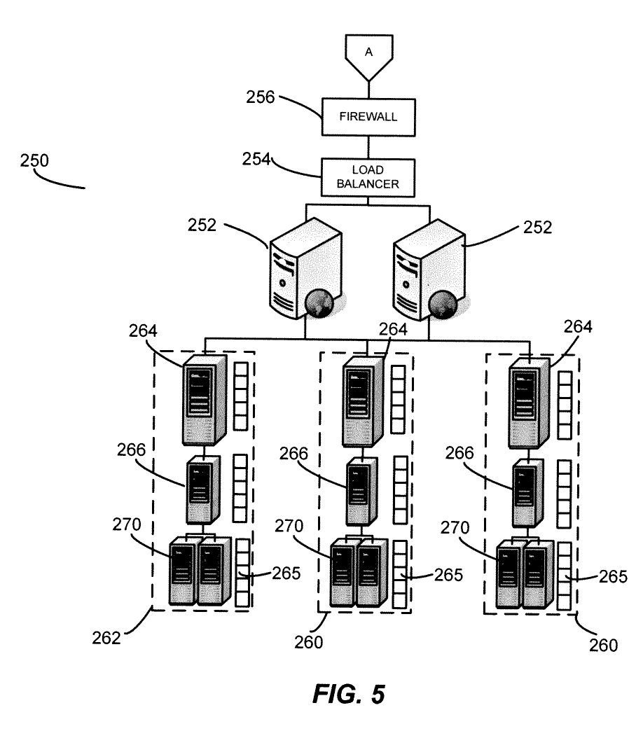

With reference to FIG. 5, the system 250 may include a distributed architecture that is N-tier with web servers 252 that may communicate with a load balancer element 254, wherein the load balancer element 254 communicates with a system firewall 256 and the web servers 252. The load balancer 254 may randomly distribute all data entering the system 250 through the firewall 256 across the web servers 252. The web servers 252 may then determine a silo 260, 262 to send the data. Thus, upon the receipt of data, the load balancer 254 may select a random web server 252, and the randomly-selected web server 252 may forward the data to a specific silo 260, 262, or to a randomly-selected silo 260, 262. The randomly-selected silo 260, 262 may then determine whether to process the data or forward the data to another silo 260, 262. The load balancer's 254 random distribution of data may reduce data latency through the system 250. The load balancer element 254 may include a method executing on a general purpose computer 50 or on any device associated with the system 250 as either software or hardware.

The system firewall 256 may provide a secure, high-speed connection to a computer network such as the Internet as illustrated in FIG. 1. The web server 252 may face the users and communicate with a number of silos 260, 262. A silo may be a conceptual collection of servers that work together through an application interface. Each silo may include, for example, an application server 264 that may execute a system application program 265. A system application program 265 running on the application server 264 may perform any coordination, transformation, or update process on the data entering or exiting the master data server 266. Further, a system application program 265 may execute on any general computing device 50 in communication with the master data server 266. A system application program 161 running on the application server 160 may include, for example, any combination of an e-mail engine, a query engine, a validation engine, a crypto engine, an award engine, or a transaction engine. Each silo may include an application server 264, wherein the application server 264 may communicate between the web server 252 and a master data server 266, and the master data server 266 may communicate with replication data servers 270. The replication data servers 270 may include a duplicate copy of the user profile data assigned to a silo 260, 262.

The silos 260, 262 may provide simple system expandability by providing more silos 260, 262 to the system. The silos 260, 262 may also provide specialized functions within the system 250. For example, the silos 260, 262 may include an administrative silo 262 and member silos 260. The administrative silo 262 may be used by the system 250 to manage system information, campaign information, or any other information that may not relate to the user profiles. The administrative silo 262 may also include a lookup table that may direct any data queries to the correct member silo 260. The member silos 260 may hold an equal or approximately equal fraction of the total amount of user information contained in the system 250 as determined by the load balancer 254. As illustrated in FIG. 5, a system comprising two member silos may each hold approximately 50% of the total system 250 user information. Upon registration, a user's information may be stored on a single, randomly selected member silo 260. The silo containing the user's registration data may be called the user's “home silo.” Each user's information may be kept in the user's “home silo,” and may remain in the home silo unless the member silos 260 are rebalanced. By randomly assigning profiles to the silos, the system load may be balanced and the number of user profiles saved to a single member silo 260 may be no more than any other individual silo 260.

With reference to FIG. 24, one function of the administrative silo 262 may be to perform distributed queries to the member silos 260. In particular, queries initiated from the administrative silo 262 may give the appearance of a single data repository, despite being distributed across multiple member silos 260. Furthermore, the distributed architecture may allow the system 250 to distribute the query across multiple system elements to minimize system processing latency. For example, at block 890, an administrative silo 262 may initiate a query for a particular set of member data from the member silos 260.

The system 250 may contain a very large number of entries that satisfy the query, but a system variable may limit the displayable number of entries to a subset of the total satisfying entries. For example, a particular query may return a total of two hundred entries, but the system 250 may only display a set of ten to the user at one time. Because the number of displayable entries is limited, at block 892, the system need only perform a “mini-query” at each member silo 260 to request only a number of satisfying entries equal to the maximum number of displayable entries. For example, if the system 250 contains two member silos 260, and the maximum number of entries the system 250 may display at one time equals ten, then the system 250 may only ask for ten satisfying entries from each silo 260. And, if there are at least ten satisfying entries on each silo 260, at block 894, the system 250 may return a total of twenty entries to the administrative silo 262 to display the first ten entries. The system 250 may also be utilized to obtain counts of the total number of records matched, regardless of pagination.

At block 896, the system 250 may then record meta data about the satisfying entries. For example, the system 250 may record the number of entries returned by each silo 260 as well as the last member identification number at which the query was satisfied at each particular silo 260. The meta data may allow the system 250 to locate a particular query's satisfying entries without saving the actual entries. At block 900, the administrative silo 262 may then join and sort the entries according to the criteria selected by the administrative user or by other criteria. One example of a process by which the data may be joined and sorted is a merge sort algorithm. At block 902, the system 250 may store the entries it cannot display due to the viewable limit. Thus, at block 904, the administrative user may be able to view up to full page of sorted data that satisfies the request.

At block 906, if the mini-queries to the member silos 260 returned more than the maximum number of viewable, at block 910, the user may display another page of satisfying entries to include the remaining entries stored at block 902. If there are no more satisfying entries in the cache and, at block 912, all system 250 entries have been checked against the query, the method may terminate. If, at block 912, more system entries remain to be checked against the query, the method may perform another set of mini-queries. Once the administrative user displays the remaining entries at block 910, the system may perform another mini-query at each silo 260 until all system 250 records are searched. For each subsequent mini-query to a member silo 260, the system 250 may request less than the maximum number of viewable entries. For example, if the maximum number of viewable entries is ten, and the number of satisfying entries originating from a particular silo 260 and currently stored at the administrative silo 262 is three, a subsequent mini-query to that particular silo 260 may be configured to request a maximum of seven satisfying entries. The system 250 may then join and sort all entries at the administrative silo 262 as before. Therefore, the total number of entries at the administrative silo 262 from any particular member silo 260 may be no more than the maximum number of displayable satisfying entries. Requesting only the fewest number of needed satisfying entries ensures the lowest possible strain on the system 250 during the query process.

To ensure that the system 250 returns unique satisfying entries with each subsequent mini-query, the system 250 may, at block 914, modify the entry meta data stored at block 896 to find a next satisfying entry at a home silo. For example, the system 250 may increment the last member identification number at which the query was satisfied at a particular silo 260 and begin the next mini-query at the record matching the incremented entry. Because each query is made up of a number of mini-queries based on the maximum viewable number of records, the system 250 may ensure that the administrative user sees only the most accurate, up-to-date member information.

Further, the administrative silo 262 need not store every record of a query in order for the administrative user to move freely backwards from the last satisfying entry to the first. Specifically, for each page of satisfying entries viewed, the administrative silo 262 may only need to store enough information to locate the records of the previous page and not the complete records. For example, by storing only the first member identification number and the corresponding member silo 260 number of the previously displayed satisfying records, the system 250 may build the previously displayed listing. The system 250 may then perform another series of mini-queries to fill in the remaining records to display a complete, previously-viewed listing.

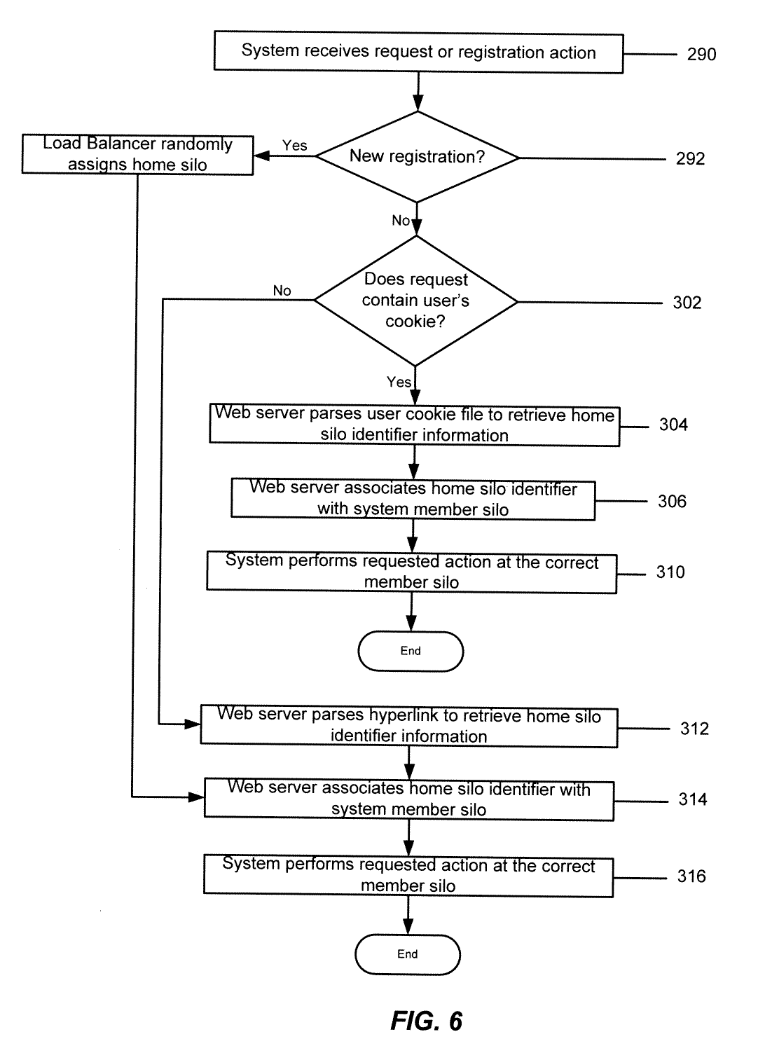

With reference to FIG. 5 and FIG. 6, and as previously described in relation to FIG. 4, the system 250 may need to periodically retrieve or update member silo 260 data to the user's home silo. To correctly identify the user's home silo upon a retrieve or update action, the user's home silo identifier may be persistently stored in several different forms. Particularly, the home silo identifier may be part of a hyperlink in a bulk e-mail sent from the system 250 to the user. Further, the home silo identifier may be part of a URL stored at the user's computer, or may be part of a cookie file. The persistent storage of the user's home silo identifier on the user's computer may also reduce any system 250 overhead associated with finding the user's information. However, once the user is at the system 250, the home silo identifier is not needed to view any successive pages during a single session; the system only requires the home silo identifier upon the first action a user takes at the system 250 during the session. Therefore, the system 250 may acquire user's unique identification number and home silo identifier through encrypted information embedded in a hyperlink included in an e-mail or from any other source. By using the encrypted information, the user may not need to login to the system 250 to complete a transaction. A user may only need to explicitly login to the system 250 when the user visits the central website without going through a hyperlink containing the encrypted identification information and the user's browser does not contain an identifying cookie, or, when the user may perform a “sensitive” action associated with a user's private information or a transaction that may decrease the user's accumulated points.

The system 250 may identify not only the user's home silo but also cached user information through the use of an “application server session.” During an application server 264 session, the system 250 may automatically store a cookie on the user's browser. The cookie may then be used to locate any cached information (including the user's home silo identifier) on successive page views. During an application server session, the cookie may be referred to as a “session cookie.” Thus, while the user is actively at the system 250 and keeping his session with the system 250 open (i.e. does not end the session by closing the browser, deleting all browser cookies, or otherwise ending his session), the system 250 may not need to actively find the user's home silo identification. The system 250 may automatically forward requests to a user's home silo based on the user's application server 264 session. The system may automatically forward the requests using an Apache™ web server 252 with ModJK extensions to a Jetty™ Java™ serviet engine application server 264.

At block 290, the system 250 may receive a user login request, registration request, or update action. If, at block 292, the system 250 receives a new registration, the load balancer 254 may forward the data to a random web server 252 and the web server 252 may assign the registration information a random home silo identifier. By randomly assigning all registrants a home silo identifier, each member silo may contain an approximately equal amount of member information. Further, the data need not retain its home silo identification for its lifetime and may be distributed to other silos 260, 262 as needed for redistribution because no particular data characteristic may tie the data to a silo 260, 262.

After storing the new member information, the system 250 may proceed to block 314. The user request or update action may come from a hyperlink embedded in a targeted e-mail generated by the e-mail engine executing as a system application program 265 on the application server 264. The hyperlink may include the user's home silo identifier information, or alternatively, the action may originate from the user's browser and include the user's cookie file.

If, at block 292, the system 250 receives a non-registration request, the system may, at block 302, determine if the request contains the user's cookie file. At block 304, if the request contains the user's cookie file, the web server 252 may parse the user's cookie file to retrieve the user's home silo identifier information. At block 306, the web server 252 may associate the home silo identifier with a particular system 250 member silo 260. At block 310, the system 250 may perform the requested action at the user's home silo 260. Therefore, the system 250 may perform the action with the user's home silo 260 without performing a lookup or redirect action when the action includes the user's cookie file.

If, at block 302, the request does not contain the user's cookie file, the request likely originated from a system-generated hyperlink that was targeted to a particular user, or the user's browser may not contain the cookie file that correctly associates the user with the user's home silo. The hyperlink therefore may contain the user's home silo identifier 260. At block 312, the web server 252 may then parse the hyperlink to retrieve the user's home silo identifier information. At block 314, the web server may associate the home silo identifier with the correct member silo 260. Therefore, the system 250 may perform the action with the user's home silo 260 without performing a lookup or redirect action when the action originates from a hyperlink containing the user's home silo identifier.

Further, the user's cookie file may contain an inaccurate home silo identifier due to data redistribution or any other reason that may result in the user's data being moved to a location other than a location indicated by the cookie file. If the inaccurate information leads the action to an incorrect silo, the receiving member silo 260 may treat the action as if no browser cookie existed and perform a lookup action to re-direct the data to the correct silo and save a new, accurate, cookie file to the user's browser. Therefore, the system 250 may perform the action with the user's home silo 260 by performing a lookup or redirect action when the action includes an inaccurate cookie file.

Further, if the user's cookie is not set, the system may perform a lookup action by accessing the lookup table residing on the administrative silo 262. Also, if the member's cookie is not set or not present, the load balancer 254 may direct the user to a random member silo 260. A system application program 265 running on the application server 264 may query the master data server 266 or the replication data servers 270 to determine if the action relates to member information stored at that silo 260. If the member data is not stored on the silo 260, the application server 264 may broadcast a request to all silos 260, 262 to find the user's home silo. Once the user's home silo 260 is found, the system 250 generates a re-direct message to the user's browser to re-establish a connection to the system 250 through the web server 252 at the proper home silo 260. The user's browser may then re-establish a connection to the system 250 with a connection message containing the correct home silo 260 identifier. Once the web server 252 receives the re-connect request, user is directed to the proper home silo 260, and the transaction may continue. At block 316, the system 250 may perform the requested action at the correct member silo 260.

As may be appreciated by one of ordinary skill in the art, the system's silo architecture is scalable and inexpensive. Further, the system is robust in that a single silo's malfunction will not degrade the function of the entire system.

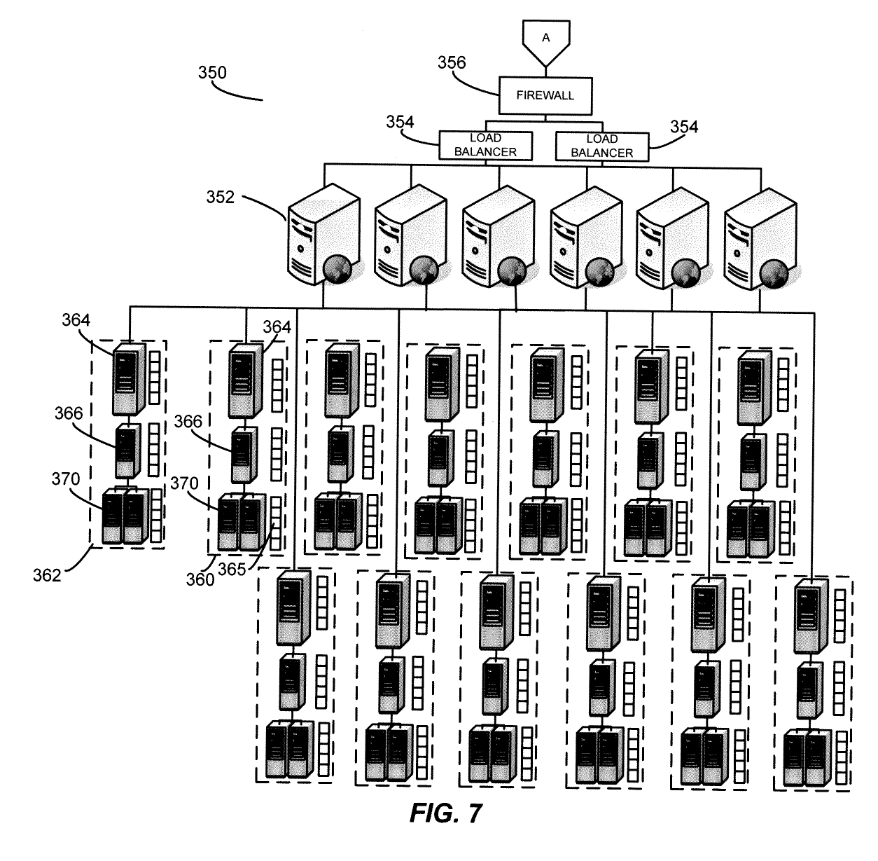

With reference to FIG. 7, the system 350 may also include a distributed architecture that is N-tier with six web servers 352 that may communicate with two load balancer elements 354, wherein the load balancer elements 354 communicate with a system firewall 356 and the web servers 352. The load balancer 354 may randomly distribute all data entering the system 350 through the firewall 356 across the web servers 352. The load balancer's 354 random distribution of data may reduce data latency through the system 350. The load balancer element 354 may include a method executing on a general purpose computer 50 or on any device associated with the system 350 as either software or hardware. The system firewall 356 may provide a secure, high-speed connection to a computer network such as the Internet as illustrated in FIG. 1. The web servers 352 may face the users and communicate with a number of silos 360, 362. A silo may be a conceptual collection of servers that work together through an application interface. Each silo may include an application server 364 executing a system application program 365, wherein the application server 364 may communicate between the web servers 352 and a master data server 366, and the master data server 366 may communicate with replication data servers 370. The master data server 366 and the replication data servers 370 may contain the member profile data to include demographic information, member transaction information, and all member-related data. Member transaction information may include records of every activity in which the member participates including registration information, purchase and activity tracking information, and point-earning information. A system application program 365 running on the application server 364 may perform any coordination, transformation, or update process on the data entering or exiting the master data server 366. Further, a system application program 365 may execute on any general computing device 50 in communication with the master data server 366. A system application program 365 running on the application server 364 may include, for example, any combination of an e-mail engine, a query engine, a validation engine, a crypto engine, an award engine, or a transaction engine. The replication data servers 370 may include a duplicate copy of the user profile data assigned to a silo 360, 362.

The silos 360, 362 may provide simple system expandability by providing more silos 360, 362 to the system. As illustrated in FIG. 7, the system may be expanded to 13 silos 360, 362. The silos 360, 362 may also provide specialized functions within the system 350. For example, the silos 360, 362 may include an administrative silo 362 and twelve member silos 360. The administrative silo 362 may be used by the system 350 to manage system information, campaign information, or any other information that may not relate to the user profiles. The administrative silo 362 may also include a lookup table that may direct any data queries to the correct member silo 360. The member silos 360 may hold an equal or approximately equal fraction of the total amount of user information contained in the system 350 as determined by the load balancer 354 random assignment. As illustrated in FIG. 7, a system comprising twelve member silos may each hold approximately 8% of the total system 350 user information. Upon registration, a user's information may be randomly stored in one member silo 360. The silo containing the user's registration data may be called the user's “home silo.” Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360. Further, the member silos 360 may have differing storage capacities. The random distribution of data stored on each member silo 360 may then be based on the percentage of system capacity represented by a particular member silo 360 by weighting the preference of the web server 352 to select a home silo 260 upon registration. Thus, a silo 360 having twice the capacity as another silo 360 may be given twice the weighting during random selection. Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360. Also, each silo 360 may poll the system 350 to determine its percentage of system capacity. Instead of random home silo selection, a closed-loop selection mechanism may, for new registrations or anonymous requests, prefer the silo 360 with the least-utilized capacity. Capacity may be measured by any suitable function and may take into account, for example, the amount of disk space available, the system processing load, the I/O capacity, the number of members, or other factors.

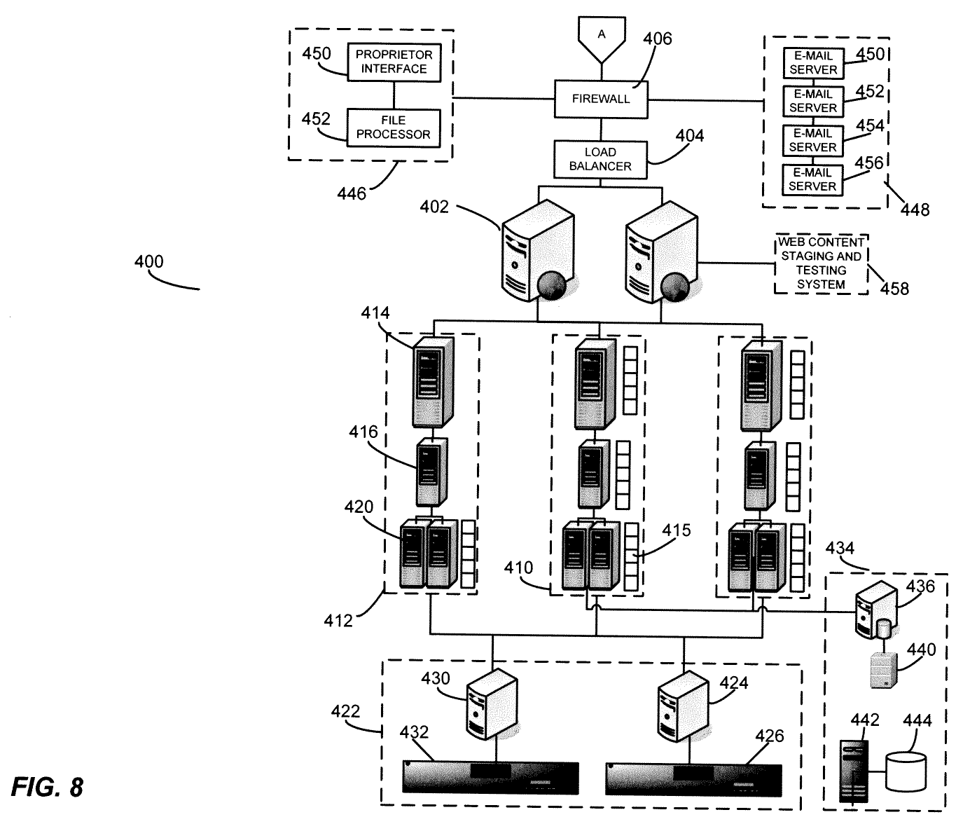

With reference to FIG. 8, the system 400 may also include several components that may complement the awarding of points as previously described. Further, the components may also be added to any of the systems 150, 250, 350 as previously described. As described above, the system 400 may include a distributed architecture that is N-tier with web servers 402 that may communicate with a load balancer element 404, wherein the load balancer element 404 communicates with a system firewall 406 and the web servers 402. The load balancer 404 may randomly distribute all data entering the system 400 through the firewall 406 across the web servers 402. The load balancer's 404 random distribution of data may reduce data latency through the system 400. The load balancer element 404 may include an application executing on a general purpose computer 50 or on any device associated with the system 400 as either software or hardware.

The system firewall 406 may provide a secure, high-speed connection to a computer network such as the Internet as illustrated in FIG. 1. The web server 402 may face the users and communicate with a number of silos 410, 412. A silo 410, 412 may be a conceptual collection of servers that work together through an application interface. Each silo 410, 412 may include an application server 414 executing a system application program 415, wherein the application server 414 may communicate between the web server 402 and a master data server 416, and the master data server 416 may communicate with replication data servers 420. A system application program 415 running on the application server 414 may perform any coordination, transformation, or update process on the data entering or exiting the master data server 416. Further, a system application program 415 may execute on any general computing device 50 in communication with the master data server 416. A system application program 415 running on the application server 414 may include, for example, any combination of an e-mail engine, a query engine, a validation engine, a crypto engine, an award engine, or a transaction engine. The replication data servers 420 may include a duplicate copy of the user profile data assigned to a silo 410, 412.

The silos 410, 412 may provide simple system expandability by providing more silos 410, 412 to the system. The silos 410, 412 may also provide specialized functions within the system 400. For example, the silos 410, 412 may include an administrative silo 412 and member silos 410. The administrative silo 412 may be used by the system 400 to manage system information, campaign information, or any other information that may not relate to the user profiles. The administrative silo 412 may also include a lookup table that may direct any data queries to the correct member silo 410. The member silos 410 may hold an equal or approximately equal fraction of the total amount of user information contained in the system 400 as determined by the load balancer 404. A system comprising two member silos may each hold approximately 50% of the total system 400 user information. Upon registration, a user's information may be randomly stored in one member silo 410. The silo containing the user's registration data may be called the user's “home silo.” Each user's information may be kept in the user's “home silo,” and may remain in the home silo unless the member silos 410 may be rebalanced. By randomly assigning profiles to the silos 410, 412, the system load may be balanced and the number of user profiles saved to a single member silo 410 may be no more than any individual silo 410.

Further, the silos 410, 412 may collectively communicate with a backup system 422. The backup system 422 may store a duplicate copy of all data stored in the system silos 410, 412. The backup system 422 may include a very high memory capacity server including a primary backup server 424. An example of a very high memory capacity server 424 may be a 2 TB array server. The primary backup server 424 may communicate with a high capacity data cache 426. An example of a high capacity data cache may be a 21 slot, 2-drive LTO2 tape library such as the Exabyte® Ultrium™ family of LTO tape drives. The backup system 422 may further include a secondary backup server 430. The secondary backup server 430 may also be a 2 TB array server. The secondary backup server 430 may also communicate with a secondary high capacity data cache 432. An example of a secondary high capacity data cache may be an LTO3 tape drive such as the Quantum® LTO-3 drive. Referring again to FIG. 8, the member silo 410 replication data servers 420 may collectively communicate with a data warehouse system 434. The replication data servers 420 may communicate with a database server 436. The database server 436 may include an extract/transform/load (ETL) server. The database server 436 may communicate with a data warehouse server 440. The data warehouse server 440 may include a 2 TB array. The data warehouse system 434 may also include legacy data related to prior versions of the points-awarding system 400. The legacy data may be stored in a modular workgroup server 442 such as the Sun Microsystems® E420R. The workgroup server 442 may further communicate with one or more data stores 444 containing the legacy data. A proprietor interface system 446 may also communicate directly with the system 400 through the system firewall 406. The proprietor interface system 446 may allow a proprietor to directly access user data stored on the system silos 410, 412. This access may allow the proprietors to collect demographic and statistical information concerning the user data on the silos 410, 412. The proprietor interface system 446 may include a proprietor interface 450. The proprietor interface 450 may be a secure connection to allow the proprietors to upload or download data to the system 446. The proprietor interface 450 may employ a protocol enabling the secure transmission of web pages such as hypertext transfer protocol over a secure socket layer (https).

The proprietor interface 450 may be in communication with a file processing element 452. The file processing element 452 may allow proprietors to access the system 400 to shop for demographics information or to store and process client information or added demographics questions for use during user registration. Proprietors may also upload member activity which is stored as member transactions in the member's home silo and which may, further, trigger both billable activity transactions and award transactions in association with each particular member and each particular campaign.

An e-mail relay system 448 may also communicate with the system 400 though the firewall 406. The e-mail relay system 448 may include four servers 450, 452, 454, 456 in communication with the system 400. The e-mail relay system 448 may direct incoming e-mails, such as delayed bounces from outgoing bulk mails sent by the system, to the proper components of the system 400.

A web content staging and testing system 458 may also communicate with the system in a variety of methods. For example, the web content staging and testing system 458 may communicate with the system 400 through the web severs 402. The web content staging and testing system 458 may comprise a number of general computing devices 50 that may provide a secure and efficient environment for system 400 administrators to develop a variety of data for the system 400 before the data may be deployed live.

### Determining Geographic Clustering

In general, the enterprise system 40 may target users during advertisement campaigns and other activities according to the demographic information stored in user profiles. While some of the techniques related to geographic clustering discussed below are known in certain applications, it is believed the geographic clustering in general, and the methods outlined below in particular, previously have not been applied to demographic information gathering. In some embodiments, the enterprise system 40 may also define a plurality of geographic clusters and associate some or all of the registered members with the respective clusters to further improve targeted promotion campaigns. To this end, the enterprise system 40 may utilize techniques discussed below with reference to FIGS. 9-12. For the purposes of brevity and simplicity, FIGS. 9-11 illustrate a particular example of determining geographic clustering based on IP addresses in class C. As is known, IP addresses are currently categorized into classes A, B, and C according to the size of a network in which these addresses are used. It is also known that a class C address uses the first three octets to identify a network and the last octet to identify a host within the network. As a result, addresses in class C support a large number of networks, each including up to 254 hosts. It will be appreciated that although the specific examples illustrated FIGS. 9-12 rely on IP addresses in class C, the techniques discussed below similarly apply to other classes of IP addresses, or to other hierarchical approaches to IP address classification. It will be further appreciated that while the discussion below refers primarily to the enterprise system 40, the techniques illustrated in FIGS. 9-12 similarly apply to the systems 150, 250, 350, or 400.

Referring to FIG. 9, each of the class C networks 502 and 504 may include a server or hub 506 and 508, respectively, through which hosts 510-514 and 515-519 are connected to the network 10. A host 510-519 may be, for example, a desktop computer, a laptop computer, a portable communicator, a wireless modem, etc. with at least one IP address. The server 506 may assign static IP addresses to some or all of the hosts 510-514 or, alternatively, the hosts 510-514 may acquire IP addresses dynamically using any suitable technique such as DHCP, for example. Similarly, the server 508 may assign IP addresses within the network 504 statically or dynamically. As illustrated in FIG. 9, the hosts 510-514 and the hosts 515-519 share the first three octets of the respective addresses in accordance with class C address allocation.

Although the physical distance between hosts in the same class C network 502 or 504 may vary, it is generally true that each of the servers 506 and 508 services between one and 254 proximate hosts due to the physical limitations of the transmission medium (e.g., signal fading) and the cost of maintaining long cable connections. Thus, when hosts 510 and 514, for example, acquire the respective IP addresses “192.12.87.12” and “192.12.87.101,” it may be assumed that these hosts operate in relative physical proximity to each other. To put it another way, each group of class C IP addresses sharing the first three octets typically corresponds to a relatively small geographic locality. As discussed in greater detail below, the enterprise system 40 may automatically correlate IP address ranges from which users 510-519 frequently access the enterprise system 40 with the available geographic information to estimate one or more localities of these users.

Still referring to FIG. 9, the users 520-529 may operate the respective hosts 510-519 to access the enterprise system 40 via the network 10. Each of the users 520-529 may be a registered member having a unique user identifier 530-539. As discussed above with reference to FIGS. 1-8, the enterprise system 40 assigns and maintains user identity information in a persistent memory to properly identify users accessing web sites hosted by the enterprise system 40. Of course, a user 520-529 need not access the enterprise system 40 from the same host or even the same network every time. For example, the user 524 using her laptop 514 in the same network 502 may access the enterprise system 40 from different IP addresses if the server 506 allocates IP addresses dynamically as hosts join the network 502. Further, the user 524 may frequently access the enterprise system 40 from work where the corresponding computer host acquires an IP address in some class C network distinct from the network 502. Still further, the user 524 may occasionally access the enterprise system 40 from a cafe franchise spread over a large urban area, each time acquiring IP addresses in different networks.

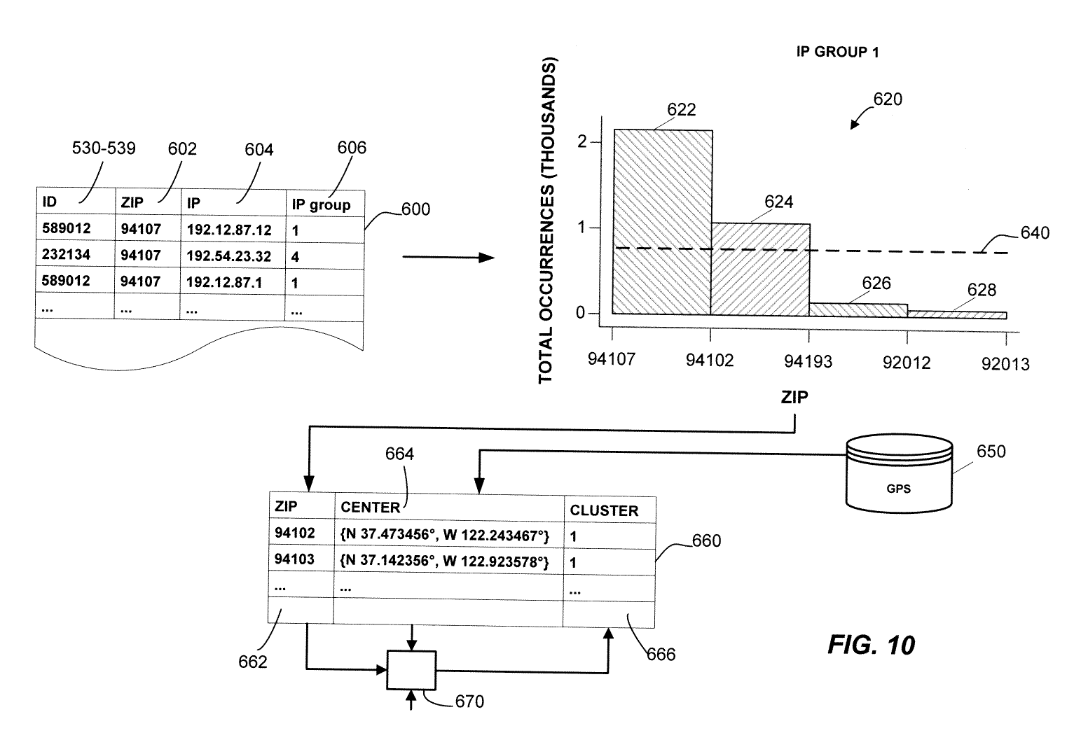

Thus, each of the users 510-519 is typically associated with at least one geographic locality which may be identified by a Zone Improvement Plan (ZIP) code used by the postal service, for example. If desired, a locality could also be identified in any other suitable manner such as a grouping of city blocks, a telephone area code, a range of Global Positioning Service (GPS) coordinates, etc. To continue with the example of ZIP codes, a user 510-519 in many cases provides his or her ZIP code to the enterprise system 40 upon registration. Additionally, the enterprise system 40 may automatically determine a list of geographic localities from which a user 510-519 typically accesses his or her enterprise account. FIG. 9, for example, illustrates that the user 522 typically operates within the ZIP code 94107 while the user 524 typically operates within the ZIP codes 94103 and 94110 which may be her home and work localities. Some of the contemplated techniques for collecting ZIP code association of the users 510-519 and determining approximate locality of IP address ranges based on the collected information are discussed next with reference to FIG. 10.

As illustrated in FIG. 10, the enterprise system 40 may maintain the history of users' access in a list 600. In particular, each entry of the list 600 may include the unique user identifier 530-539, the ZIP code 602 reported by the corresponding user (if available), the IP addresses 604 from which the transaction originated, and an IP group identifier 606 which the enterprise system may assign based on the shared octets of the corresponding IP addresses. To take one specific example, the user having the identifier 589012 and residing within the 94107 area code may log into his enterprise account from the IP address 192.12.87.12 and, at a later time, from the IP address 192.12.87.1 (in this particular example, the user has elected to submit her ZIP code to the enterprise system 40). Because the enterprise system 40 associates all addresses in the 192.12.87.xxx range with address group 1, both of the entries corresponding to these events specify the same number 1 in the group identifier 606.

Upon creating a statistically significant number of entries in the list 600, the enterprise system 40 may automatically correlate IP address groups with ZIP codes of the corresponding members. Referring still to FIG. 10, a histogram 620 illustrates one possible statistical approach to determining which ZIP codes are strongly linked to a particular address group. Specifically, the example histogram 620 visually illustrates the degrees of correlation between several ZIP codes and group 1 that includes IP addresses in the 192.12.87.0-192.12.87.255 range. Each of the stacks 622-628 of the histogram 620 corresponds to a certain ZIP code, and the height of each stack 622-628 represents the number of times the registered users 510-519 who have provided this ZIP code as part of their registration procedure accessed the enterprise system 40 from an IP address in group 1.

The enterprise system may compare the height of each stack 622-628 to a threshold 640 to determine whether the stack has enough correlation with the IP address group. In the example illustrated in FIG. 10, the stack 622 corresponding to the ZIP code 94107 and the stack 624 corresponding to the ZIP code 94102 have sufficient correlation with group 1, while the ZIP codes 92012 and 92013 are represented by relatively low stacks 626 and 628. Accordingly, the enterprise system 40 may determine that hosts with IP addresses 192.12.87.xxx are primarily concentrated in the geographic area that includes ZIP codes 94107 and 94102. Similar application of this approach to other IP address groups and ZIP codes may yield an approximate mapping of IP addresses to geographic areas.

Further, the enterprise system 40 may use the IP address group/ZIP code correlation information to define geographic clusters. In particular, the enterprise system 40 may include or communicate with an external GPS database 650 to obtain coordinates associated with each ZIP code. For example, the GPS database 650 may supply the coordinates of a geographic center of a particular ZIP code to the enterprise system 40 to generate a table 660. As illustrated in FIG. 10, each entry of the table 660 may include a ZIP code field 662, a geographic center coordinates 664, and a cluster identifier field 666. The enterprise system 40 may populate the cluster identifier field 666 based on, for example, the calculated distances between pairs of geographic centers stored in the field 664, groupings of ZIP codes having adjacent numbers, or according to any other suitable principle. To this end, a cluster calculator 670 may receive inputs from the fields 662 and 664 of the table 660 and, optionally, from additional entities to generate specific values for the field 666.

Additionally, the enterprise system 40 may use the GPS database 650 to calculate distances between geographic centers of ZIP codes that the cluster calculator 670 does not necessarily place into the same cluster. In an embodiment, the table 660 may include an additional field to determine the geographic center of each cluster so that the enterprise system 40 may approximately assess the distance between IP address groups in different clusters.

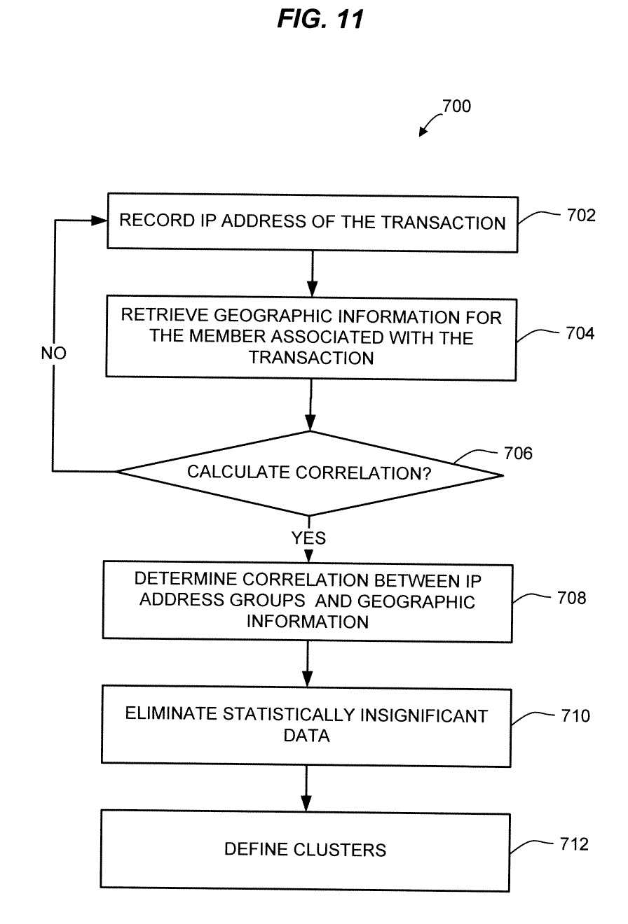

Now referring to FIG. 11, an example procedure 700 may be implemented by the application server 160 (see FIG. 3) or another one or several components of the enterprise system 40. In block 702, the enterprise system 40 may receive a transaction request from a member such as, for example, a login attempt, a click-through on a banner including a redirection link to the enterprise system 40, etc. The enterprise system 40 may record the IP address from which the transaction originated. Referring back to FIG. 10, each new transaction registered in block 702 may correspond to a new entry of the list 600 (see FIG. 10). Upon receiving the transaction request and the corresponding IP address, the enterprise system 40 may identify the user based on, for example, the unique user identifier, the first and last names of the user, or other user-specific information (block 704). If the member silo 154 includes the user's geographic information such as his or her ZIP code, home address, urban neighborhood information (e.g., “East Village”), the enterprise system 40 may record this information in the list 600. In an embodiment, the enterprise system 40 may additionally translate the available geographic information into a single format of the field 602 in the table 600. For example, if a user's geographic information specifies a city neighborhood but not the ZIP code, the enterprise system 40 may approximately map the neighborhood to one or several ZIP codes using a look-up table or some other mapping function. It will be also noted that in addition or as an alternative to ZIP codes, the list 600 may maintain other geographic information such as the user's address, telephone area code, etc.

In block 706, the procedure 700 determines whether the list 600 contains enough information to perform a statistical analysis. In an embodiment, the enterprise system 40 initiates a statistical analysis upon reaching a certain number of entries in the list 600. Alternatively, the enterprise system 40 may periodically analyze some or all of the accumulated data (e.g., once a week). If the amount of data in the list 600 is insufficient, the procedure 700 returns to block 702 to acquire additional data.

Otherwise, the procedure 700 determines a correlation between each IP address group and the geographic information (block 708). Next, the procedure 700 may eliminate statistically insignificant data (block 710). As discussed above, a user may sometimes access the enterprise system 40 from the road or another temporary location, and the corresponding IP address group would correlate only weakly with the ZIP code of the user. On the other hand, a sudden change in the IP address group could also indicate that the user's account has been hijacked, or that the user has relocated without updating her profile.

Finally, in block 712, the procedure 700 defines clusters as sets of one or several ZIP codes, one or several IP address ranges, or other geographic characteristics. Additionally, the block 712 may include a full or partial scan of the member silos 154 or 260 so that the procedure 700 identifies each registered user associated with one of the ZIP codes in a particular cluster. In this manner, the enterprise system 40 may associate each geographic cluster with a geographic area as well as a set of registered users. In some embodiments, the procedure 700 may identify some registered users with more than one geographic cluster if, for example, the user provides her ZIP codes both at home and at work addresses, or if the enterprise system 40 detects a strong statistical correlation between the user and more than one ZIP codes.

It will be appreciated that the enterprise system 40 may use geographic cluster information in the table 660 for various purposes including targeted advertisement, fraud detection, changes in user residence or work location, etc. Further, it will be appreciated that some registered users 510-519 may chose either not to provide ZIP code information or other geographic information at all, or deliberately enter wrong information (e.g., “12345” as the ZIP code which the users makes up to fulfill the five-digit requirement). By using the techniques discussed above, the enterprise system may determine, with a reasonable degree of certainty, the ZIP code or at least the geographic cluster of each user.

In one aspect, the enterprise system 40 may efficiently target users in advertisement campaigns and promotions of local businesses. For example, a local athletic club may wish to target users who reside within one of several specified area codes. In addition to using the ZIP code information provided by users, the enterprise system may derive ZIP code information or geographic cluster information for users who did not provide such information, and target both types of users in an email campaign, via personalized web pages, by using text messaging, etc. In some cases, a local business may not select any target ZIP codes at all but may instead specify an approximate number of customers to be targeted during a promotion. To efficiently service such requests, the enterprise system 40 may maintain an additional field in the table 660 to keep track of the number of users within each geographic cluster. When requested to target a specified number of people, the enterprise system 40 may then select one or several appropriate geographic clusters to determine whom the particular campaign should target.

More specifically, FIG. 12 illustrates a procedure 750 that the administrative silo 156 (see FIG. 3) or another component of the enterprise system 40 may implement to conduct a targeted advertisement campaign using the geographic clustering information discussed above with reference to FIGS. 10 and 11. In block 752, the procedure 750 may process a request from a merchant to advertise a certain offer and, in particular, to target users local to the geographic area in which the merchant operates. For example, the merchant could be a local restaurant or video rental store that seeks to attract local customers. If, as illustrated in block 754, the merchant specifies one or several ZIP codes to which the enterprise system 40 should restrict the campaign, the procedure 750 may directly proceed to block 760. Otherwise, the procedure 750 may obtain the requesting merchant's geographic information (block 756) by analyzing the merchant's IP address, for example, and automatically generate a list of target geographic areas (e.g., geographic clusters, ZIP codes, etc.) (block 758). In some embodiments, the merchant could specify the target geographic location in one of several recognized formats (e.g., city blocks, GPS coordinates, etc.) and the procedure 700 may convert the target geographic location into a set of ZIP codes at least approximately corresponding to the location specified by the merchant.

In block 760, the enterprise system 40 may identify users who reside in, work in, or are otherwise associated with the target geographic area. In some embodiments, the table 660 (see FIG. 10) includes a field that identifies the first user in a linked list that includes every registered user associated with the specified ZIP code. In other embodiments, the enterprise system 40 may perform ad hoc searches through the member silos 154 or 260 (block 760). As yet another alternative, the enterprise system 40 may maintain a separate table listing users associated with each ZIP code.

Finally, in block 762, the procedure 750 may initiate the campaign or promotion by sending out email messages to the users identified in block 760, updating the web pages displayed and personalized by the enterprise system 40 to each registered user, or updating banner information on third-party web sites.

In another aspect, the enterprise system 40 may use statistical aberrations discovered in the course of generating a histogram 620 or applying a similar analytical technique to extrapolate additional demographic data. For example, a certain user may appear to be highly mobile based on his or her pattern of IP address usage and may therefore be a good candidate for advertisement campaigns or promotions targeted at people with a mobile life style.

In yet another aspect, the enterprise system 40 may target users temporarily present in a certain locality. Referring back to FIG. 9, for example, the enterprise system 40 may associate the user 524 with one or several geographic clusters that include the ZIP codes 94103 and 94110, e.g., clusters 1 and 5. However, if the enterprise system 40 detects recent activity of the user 524 in geographic cluster 24, the enterprise system 40 may target the user 524 in a promotion directed at the “permanent” residents of cluster 24.

It is further contemplated that the enterprise system 40 may use the techniques discussed above to automatically determine a probable relocation of a registered user. For example, the user 520 (see FIG. 9) could originally supply ZIP code 94107 to the enterprise system 40. Upon moving to another location with a different ZIP code, the user 520 could forget to update his enterprise account. In some embodiments, the enterprise system 40 may maintain user-specific statistics to detect a significant deviation in the IP address ranges from which the user 520 initiates transactions from the expected range of IP addresses. In particular, the enterprise system 40 may use the histogram 620 to determine that the one or several IP groups associated with these transactions do not display a statistically significant correlation with the ZIP code 94107 currently on file for the user 520. Accordingly, the enterprise system 40 may issue an automatic reminder in the form of an email message, for example, to prompt the user 520 to update his profile.

With respect to fraud detection, the enterprise system 40 may use the techniques discussed above to determine whether a user's account has been hijacked. For example, the enterprise system 40 may flag a user account if the transactions repeatedly originate from within an IP address range not associated with any of the geographic areas in which the user typically operates. To determine if the user has relocated or the account has been hijacked, the enterprise system 40 may automatically trigger a confirmation procedure such as a request to confirm certain confidential information to prove the identity of the user. In another aspect, multiple sign-up requests from the same IP address also could be indicative of fraudulent activity. The enterprise system 40 may in this case alert a human operator, generate confirmation message, or take other steps to prevent fraud.

It will be also noted that the online enterprise system 40 may personalize a “home” page for each registered member according to his or her preferences and the available demographic information. One such technique is described in the U.S. Patent Application No. 11/832,013, entitled “System and Method for Personalizing Web Pages by Pre-fetching Subsets of Individual Member Data,” the entire disclosure of which is hereby expressly incorporated herein by reference. Thus, in addition to or instead of sending email or text messages to target users as described above, the enterprise system may also customize the web pages of the targeted users to display local advertisements and promotions.

Awarding Members for Referring Business Entities to the Enterprise System

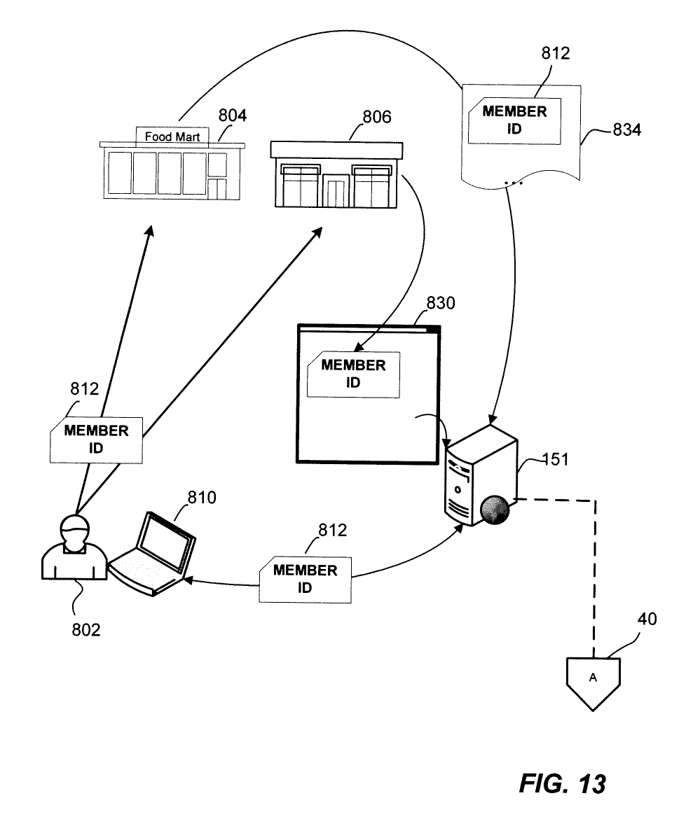

As briefly indicated above, the enterprise system 40 may award users with redeemable points or other forms of credit for referring local businesses to the enterprise system 40. FIG. 13 schematically illustrates several interactions between a user 802, the enterprise system 40, and business entities 804-806 for which the enterprise system 40 automatically awards points to the user 802. In particular, the user 802 may operate a computer or host 810 to interact with the enterprise system 40 via the web server 151 (see FIG. 3). In a typical interaction, the user 802 supplies a user identifier 812 during the login process or in response to a request by the web server 151. Using the user identifier 812, the enterprise system 40 may access the profile of the user 802 to award points, update the demographic information, etc. Similarly, the business entities 804-806 may access the enterprise system 50 via a network connection as indicated by arrows 820 and 822.

In one scenario, the user 802 may recommend that the business entity 804 register with the enterprise system 40 to take advantage of the highly effective and targeted advertisement services the enterprise system 40 offers to the participating merchants. To register with the enterprise system 40, the business entity 804 may, for example, access a registration web form 830 on a web page maintained by the web server 151. Alternatively, the business entity 804 may send an email message 834 having a predefined format to the enterprise system 40. In either case, the business entity 804 may include the user identifier 812 in the form 830 or in the email message 834. Preferably but not necessarily, the user identifier 812 is in a predefined location on the form 830 or the email message 834 for efficient identification by the enterprise system 40. Upon receiving the web form 830 or the email message 834, the enterprise system 40 may extract the user identifier 812, identify the user 802 based on the user identifier 812, and update the profile of the user 802 with an event information specifying the request received from the business entity 804.

In some embodiments, the business entity 804 may supply a predefined referral code to the enterprise system 40 instead of the user identifier 812. The enterprise system 40 may generate user-specific referral codes either automatically or upon request from the corresponding user 802. Each referral code may correspond to a particular user without revealing the user 12. It will be appreciated that in this manner, the enterprise system 40 may provide an additional level of protection of registered users' privacy while allowing candidate business entities to unambiguously specify the referring party. Further, the business entity 804 may supply the referral code as part of a URL to some embodiments of the enterprise system 40. For example, a certain user may have the member identity 274342. For the purposes of business entity referrals, the enterprise system 40 may generate the referral code VKFKEP that corresponds to the user 274342, include the referral code VKFKEP in a URL www.mypoints.com/VKFKEP (where mypoints.com identifies the enterprise system 40), and provide the user with a convenient method for distributing the URL to business entities. To continue with this example, the user may print out a referral form with the URL www.mypoints.com/VKFKEP and give the referral form to the business entity 804 or its representative. When business entity 804 accesses the enterprise system 40 via www.mypoints.com/VKFKEP, the enterprise system 40 can easily identify the user 274342. Moreover, the referral code VKFKEP may encode additional information such as the time when the user 274342 requested the referral form, for example.

If desired, the web form 830 or the mail message 834 may include a business transaction request other than a request to register with the enterprise system 40. For example, the business entity 804 may merely request information from the enterprise system 40. Depending on the type of transaction requested by the business entity 804, the enterprise 40 may award the user 802 according to a different award arrangement. Further, it is contemplated that in some cases, a user may refer an already participating merchant to the enterprise system 40 to enroll in an additional program or subscribe to another service, for example. In short, the enterprise system 40 may award users for various transactions requested by business entities; however, the enterprise system 40 preferably specifies and enforces corresponding conditions.

In general, the enterprise system 40 may define award conditions and rules of any desired complexity. As one example, the enterprise system 40 awards users in proportion to the amount of money spent by the referred business entity. Additionally or alternatively, the enterprise system 40 may allocate a certain award amount only if the referred business entity engages in commercial activity in cooperation with the enterprise system 40 within a predetermined period of time.

Still referring to FIG. 13, the business entity 804 or 806 may be, for example, a local restaurant or a café, a store, a dry cleaning service, a rental store, a used book store, or any other business with limited internet, television, and radio exposure. The user 802 may contact the business entities 804 and 806 in any suitable manner such as, for example, by walking into local stores and distributing business cards or flyers. To facilitate the distribution of information regarding the enterprise system 40 by registered members such as the user 802, the enterprise system 40 may provide easily printable flyers, for example, specifying the procedure for registering with the enterprise system 40 as well as the user's identifier or a referral code. In this sense, the enterprise system 40 may automatically personalize flyers for each registered user to provide him or her with an additional incentive to actively attempt to recruit local businesses.

Alternatively, users may reach business entities via electronic means such as email, for example. It is contemplated that a user may send an email message to an owner or manager of a local store inviting him or her to subscribe to the services provided by the enterprise system 40. Because the user may use his personal account to send the message, the merchant's email provider will likely deliver the email and not categorize the message as “spam.” As is well known, distribution of mass emails and especially of non-targeted blanket messages is associated with a number of technical (e.g., filtering) and legal issues. However, an individual user may be able to freely contact another individual whom he or she knows, such as a business owner or manager. In this embodiment, the user's email may include, for example, a link to the home page of the enterprise system 40 with the embedded identifier of the user. Upon clicking on the link, the recipient of the email may cause the enterprise system 40 to receive both a registration request and the identifier of the referring user.

On the other hand, the enterprise system 40 may also provide a candidate participating merchant such as the referred business entity 804 with an incentive to report the user identifier of the referring user 802. For example, the enterprise system 40 may provide a discount or another type of an attractive arrangement to each candidate merchant that specifies a referrer.

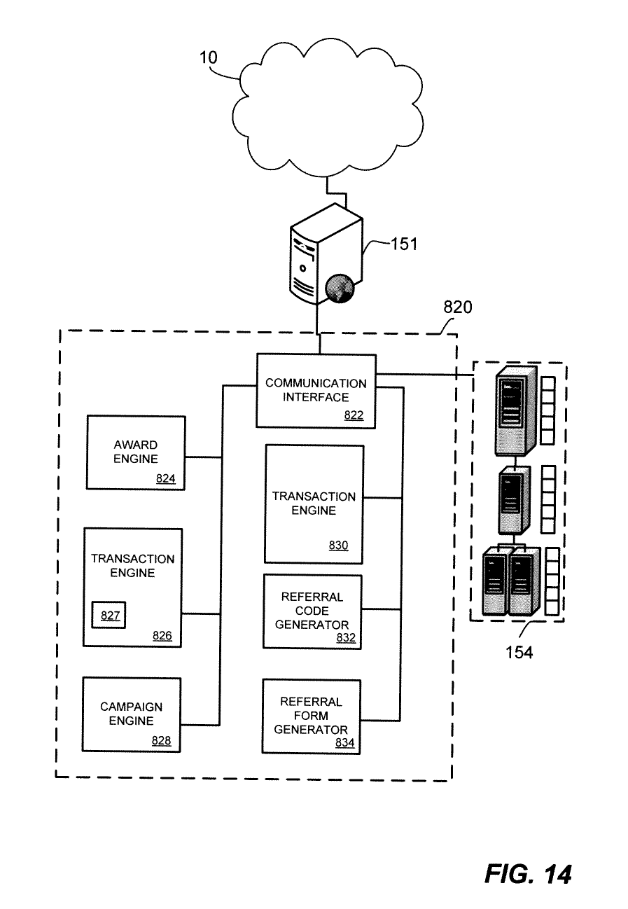

FIG. 14 illustrates several components 822-834 of a referral award subsystem 820 of the enterprise system 40. The subsystem 820 may be primarily responsible for awarding users with redeemable points and/or other incentives for referring business entities to the enterprise system 40. In some embodiments, the subsystem 820 may include dedicated hardware and/or firmware to support the components 822-834. In other embodiments, the subsystem 820 may correspond to a logical grouping of software or firmware components which execute on the application server 160, the administrative silo 156, or an administrative server group, for example. Some of the components, such as the award engine 824, for example, may support other functions of the enterprise system 40 in addition to the functionality of the referral award subsystem 820. In some of these embodiments, some or all of the components 822-834 may be software routines stored on a computer-readable medium and executable on a processor. It will be further noted that the components 822-834 may be distributed over various devices of the enterprise system 40 in any desired manner.

The example referral award subsystem 820 illustrated in FIG. 14 may execute on the application server 160 and include a communication interface 822, the award engine 824, a transaction engine 826, a campaign engine 828, a geographic cluster calculator 830, a referral form generator 832, and a referral code generator 834. In operation, the communication interface 822 may receive transaction requests from candidate business entities and referral codes corresponding to the referring registered users, retrieve user information from profile storage module of the member silo 154, and facilitate communications between the modules 824-834 coupled to the communication interface 822 and the network 10. The award engine 824 may include one or several routines to process and store referral indications received with or as part of transaction requests, retrieve award rules for different types of referrals, allocate referral awards to users according to the retrieved award rules, allocate other awards to users such as point awards for interacting with participating merchants or the enterprise system 40 in a predefined manner, etc.

The transaction engine 826 may register user interactions with the enterprise system 40 as described above with reference to FIG. 4. If desired, the transaction engine 826 may also award points in addition to or instead of the award engine 824. The transaction engine 826 may also include an IP address tracking module 827 to record IP addresses associated with user transactions. If desired, the IP address tracking module 827 may be configured to record both the IP address from which the transaction originated and the IP addresses of intermediate hosts (i.e., the routing history or path of the transaction), when such information is available.

With continued reference to FIG. 14, the campaign engine 828 may electronically distribute information related to promotion campaigns to users registered with the enterprise system 40. As discussed above, campaigns typically target users matching certain demographic attributes. Further, the geographic cluster calculator 830 may determine the geographic locality of some or all of the registered users according to the techniques discussed above. For example, the geographic cluster calculator 830 may process geographic information received from some of the users and the IP address information corresponding to one or several transactions of the respective user. Still referring to FIG. 14, the referral code generator 832 may generate referral codes as substantially unique sequences of alphanumeric characters or other symbols which the enterprise system 40 may distribute to the registered users to promote the referral award program. Also, the referral form generator 834 may generate referral forms for distribution by the registered users to business entities. Preferably but not necessarily, the referral forms may be user-specific and may include the corresponding referral codes.

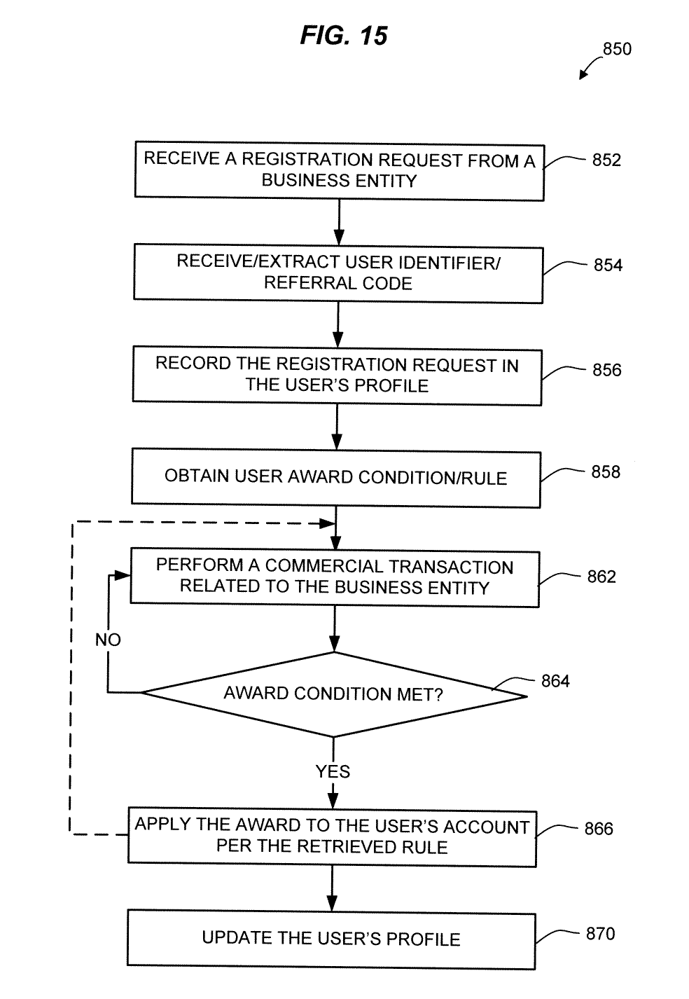

Referring to FIG. 15, the enterprise system 40 may execute the procedure 850 to process various transaction requests from candidate merchants and other business entities. In block 852, the procedure 850 receives a transaction request from an interested candidate such as the business entity 804 illustrated in FIG. 13, to take one example. The enterprise system 40 may then check whether the transaction request specifies a referrer and extract the user identifier of the referring user if this parameter is available (block 854). Next, the enterprise system 40 may access the account of the user whose identifier has been extracted from the transaction request in block 854 and update the account with pending award information related to the received transaction request (block 856). More specifically, the pending award information may specify the referred party, the type of transaction request, the time the transaction request was received by the enterprise system 40, and other relevant information.

In block 858, the procedure 850 obtains the conditions and rules associated with the transaction request from the administrative silo 156 or another system component. For example, the transaction request may include a payment authorization for a certain advertisement campaign in addition to the registration request. The corresponding rule may specify an amount of award points to be unconditionally allocated to the referring user's account as well as additional award points which the referring user may receive based on the future activity of the referred business entity. As another example, the transaction request may include a registration request only, and the corresponding rule may specify that the referring user is eligible for award points upon a successful completion of a monetary transaction between the referred business entity and the enterprise system 40. To take yet another example, a rule obtained in the block 858 may specify a percentage (e.g., 2%) of the amount spent by the referred business entity to be allocated to the referring user as an award. It is also contemplated that percentage awards may expire within a certain period of time.

In blocks 862-864, the procedure 850 may periodically check whether the referred business entity has satisfied the conditions obtained in block 858. For example, the procedure 850 may run as a background task that periodically wakes up to check whether any of the referring users have become eligible for award points. Finally, in block 866, the procedure 850 allocates the award to the referring user and updates the corresponding field in the user's profile (block 870). In some cases such as providing percentage awards, for example, the procedure 850 may return to block 862 to credit the referring user for the next transaction.

As discussed above with reference to FIGS. 9-12, the enterprise system 20 can determine the locality of most or all registered users to better target advertisements, particularly those related to local businesses. By offering to conduct such targeted advertisement campaigns, the enterprise system 40 may attract more local businesses. Moreover, the enterprise system 40 may specify in advance the scope of local advertisement to a business entity and correspondingly adjust the price of a campaign with a high degree of precision. For example, the enterprise system 40 may establish that a promotional campaign of a local restaurant directed at the residents of a geographic area that encompasses ZIP codes 94106 and 94107 may reach approximately 610 registered users. Further, the enterprise system 50 may determine that a number of users normally associated with remote ZIP codes have recently logged in from hosts having IP addresses that correspond to the 94106 and 94107 ZIP codes, and similarly target these “visiting” users in the local advertisement campaign.

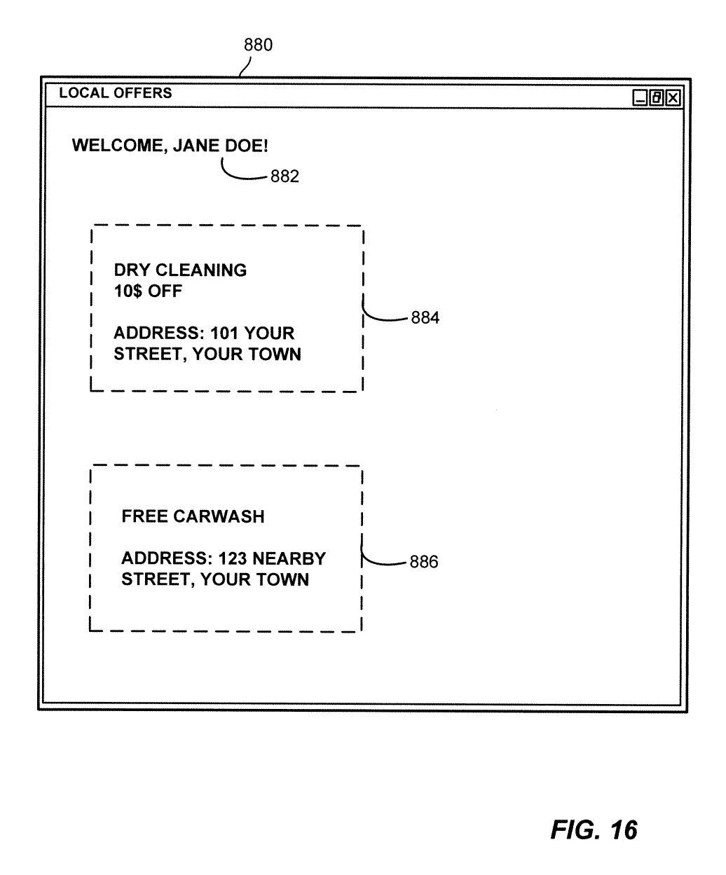

FIG. 16 illustrates an example of a personalized web page that the enterprise system 40 may display to a registered user. A user 520-529 or 802 may access the enterprise system 40, provide her user identifier (and, optionally, a password or a passcode), and access the home page to view the account status, award point balance, and other information. Additionally, the user may click on a link or a tab to view a local offers page 880. Based on the user's reported ZIP code or geographic information extrapolated from the user's current IP address using the techniques discussed above, the enterprise 40 may identify those business entities that are local or proximate to the user's place of residence or work. As illustrated in FIG. 16, the web page 880 may include a personalized greeting 882 and several location-specific offers or virtual coupons 884 and 886. Meanwhile, another user accessing the enterprise system 40 from a different location may see different offers on his personalized web page.

Generally with respect to FIGS. 1-16, it will be further noted that although many of the examples above refer to business entities and commercial transactions, the methods of the present disclosure may similarly apply non-business entities and other third-party entities that conduct non-commercial activities. For example, a third-party entity could be a school, a church, a magazine, an online forum, etc. Accordingly, in addition to (or instead of) allocating award points to a corresponding award, an enterprise system (such as the enterprise system 40 or a similar information gathering or online marketing system) may credit users for referring business and non-business entities using a variety of methods such as offering free subscriptions to online services, for example.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A method in a computer system for automatically crediting a registered user for referring a candidate third-party entity to an online system that facilitates transactions between a plurality of users and a plurality of participating third-party entities, wherein the third party entity is at least one of a commercial, government, or non-profit entity, and wherein the online system maintains a personal account for each registered user; the method comprising:
receiving a transaction request from the candidate third-party entity;
receiving an identifier associated with the transaction request, wherein the identifier corresponds to the registered user;
identifying the registered user using the identifier;
retrieving a crediting rule associated with the transaction request; and
automatically crediting the registered user in accordance with the crediting rule.

2. The method of claim 1, wherein the online system is a commercial system that facilitates commercial transactions between the plurality of users and the plurality of participating third-party entities.

3. The method of claim 1, wherein the crediting rule specifies an award condition; and wherein automatically crediting the registered user includes allocating the award to a personal account associated with the registered customer if the award condition is met.

4. The method of claim 3, wherein allocating the award to the personal account includes allocating a certain number of award points specific to the online commercial system and redeemable for a product or a service.

5. The method of claim 3, wherein retrieving the award condition includes obtaining a threshold monetary amount to trigger an award allocation; and wherein allocating the award if the award condition is met includes:
determining a monetary amount associated with the received transaction request;
comparing the monetary amount to the threshold monetary amount; and
allocating the award to the personal account associated with the registered consumer if the monetary amount is greater than or equal to the threshold monetary amount.

6. The method of claim 3, wherein allocating the award if the award condition is met includes:
adding information indicative of the received transaction request to the personal account associated with the registered consumer;
maintaining an aggregate count associated with subsequent commercial transactions between the candidate third-party entity and the online commercial system; and
allocating the award to the personal account associated with the registered consumer in response to determining that the aggregate count reaches a value specified by the award condition.

7. The method of claim 1, wherein the candidate third-party entity is a business entity associated with a commercial activity.

8. The method of claim 1, wherein receiving a transaction request from the candidate third-party entity includes receiving a registration request, wherein the registration request includes a request to register the candidate third-party entity with the online system by associating the candidate third-party entity with the plurality of participating third-party entities.

9. The method of claim 1, wherein the online system includes an information gathering system that collects demographic information related to the plurality of users; wherein receiving a transaction request from the candidate third-party entity includes receiving a request to advertise a consumer promotion associated with the candidate third-party entity; the method further comprising:
conducting a targeted campaign to advertise the consumer promotion, including:
obtaining a set of target demographic attributes associated with consumers targeted by the consumer promotion;
selecting a set of consumers from the plurality of users based on the demographic information of each of the plurality of users, wherein the demographic information of each one in the selected set of consumers substantially corresponds to the set of target demographic attributes; and
transmitting information related to the consumer promotion to the selected set of consumers.

10. The method of claim 9, wherein transmitting information related to the consumer promotion includes at least one of generating an email message or personalizing a web page automatically displayed to the corresponding one of the selected set of consumers upon accessing the online commercial system.

11. The method of claim 9, wherein obtaining the set of target demographic attributes includes receiving an indication of a geographic locality of the candidate third-party entity; and wherein selecting the set of consumers from the plurality of users includes selecting users associated with the geographic locality.

12. The method of claim 11, wherein selecting consumers associated with the geographic locality includes determining the geographic locality of at least some of the plurality of users by correlating geographic information available for the plurality of users with IP addresses from which the plurality of users originates transactions with the online system.

13. The method of claim 1, further comprising generating a referral form on a distributable medium for distribution by the registered user, including providing at least one the identifier or a code uniquely corresponding to the identifier.

14. An online system facilitating commercial interactions between a plurality of registered users and a plurality of participating business entities, the system comprising:
a profile storage module to store a plurality of user profiles corresponding to the plurality of respective registered users;
a communication interface to receive a transaction request from a candidate business entity associated with commercial activity and a referral code associated with the transaction request, wherein the referral code corresponds to a referring one of the plurality of registered users; and
an award engine communicatively coupled to the profile storage and the communication interface, the award engine including:
a first routine to store a referral indication in one of the plurality of user profiles associated with the referring one of the plurality of registered users, wherein the referral indication corresponds to the transaction request;
a second routine to retrieve an award condition associated with the transaction request; and
a third routine to apply a referral award to the user profile based on the stored indication and the award condition.

15. The online system of claim 14, wherein the online system further comprises a transaction engine to register user interactions with the online system; and wherein the award engine further includes a fourth routine to allocate awards to at least some of the plurality of users according to the user interactions.

16. The online system of claim 14, wherein the communication interface receives the transaction request via one of an email message or a web form.

17. The online system of claim 14, wherein the transaction request includes a set of target demographic attributes, and wherein the transaction request specifies a promotion campaign targeted at users matching the target demographic attributes; the system further comprising:
a campaign engine to electronically distribute information related to the promotion campaign to users included in the plurality registered users and matching the target demographic attributes.

18. The online system of claim 17, further comprising:
a transaction engine to register user interactions with the online system, including an IP address tracking module to record an IP address associated with each user interaction; and
a geographic cluster calculator to determine a geographic locality of at least some of the plurality of registered users based on the recorded IP addresses associated with the user interaction and geographic information received from some of the plurality of users.

19. The online system of claim 17, wherein the set of target demographic attributes specifies a geographic location of the candidate business, and wherein the campaign engine targets users proximate to the candidate business.

20. The online system of claim 17, wherein the online system levies a charge on the candidate business entity dependent on a number of ones in the plurality of registered users that match the target demographic attributes; and wherein the referral award is proportionate to the charge.

21. The online system of claim 14, further comprising:
a referral code generator to generate the referral code as a substantially unique sequence of symbols for one of the plurality of registered users; and
a referral form generator to generate a referral form for distribution by the one of the plurality of registered users to at least one business entity not included in the plurality of participating business entities, wherein the referral form includes the referral code for submission to the online system.

22. A method in a computer system for reliably crediting a registered user of an information gathering system for an entity referral comprising:
registering a plurality of users for participation in a service provided by the information gathering system, wherein each of the plurality of users receives awards points redeemable for a product or a service for interacting with a plurality of participating entities in a predefined manner;
assigning a respective referral code to at least some of the plurality of users, wherein each referral code corresponds to exactly one of the plurality of users;
receiving a transaction request from a candidate entity, wherein the candidate entity is one of a commercial, government, or non-profit entity, and wherein the transaction request is associated with a directed commercial campaign;
receiving a referral code associated with the transaction request, wherein the referral code corresponds to one of the plurality of users;
processing the transaction request to generate an award eligibility indication; and
conditionally allocating a referral award to the one of the plurality of users in accordance with the award eligibility indication.

23. The method of claim 22, wherein processing the transaction request includes:
receiving a payment from the candidate entity; and
comparing the payment to a predefined condition associated with the referral award.

24. The method of claim 23, wherein conditionally allocating the referral award includes allocating a number of award points to the one of the plurality of users, wherein the number is proportionate to the payment received from the candidate entity.
